(19) United States
(12) Patent Application Publication
(10) Pub. No.: US 2022/0186742 A1
(43) Pub. Date: Jun. 16, 2022

(54) AXIAL FAN, AIR-SENDING DEVICE, AND REFRIGERATION CYCLE APPARATUS

(71) Applicant: Mitsubishi Electric Corporation, Tokyo (JP)

(72) Inventors: Takahide TADOKORO, Tokyo (JP); Katsuyuki YAMAMOTO, Tokyo (JP)

(21) Appl. No.: 17/439,952

(22) PCT Filed: May 21, 2019
(86) PCT No.: PCT/JP2019/020103

§ 371 Date: Sep. 16, 2021

(51) Int. Cl. F04D 29/38; F25D 17/06

(52) U.S. Cl. CPC F04D 29/384; F05D 2240/304; F25D 17/067

(57) ABSTRACT

An axial fan includes a hub and blades. The hub has a rotating shaft, and is configured to be driven to rotate. The blades are provided to the hub, and each have a front edge portion and a rear edge portion. In a state in which the blades rotate to generate an airflow, the front edge portion is placed most upstream in the airflow, and the rear edge portion is placed most downstream in the airflow. In a shape of the blades rotated and projected onto a meridian plane that covers shapes of the blades and a shape of the rotating shaft, the front edge portion has an outline represented by a front-edge projected portion having a first recess portion formed in a recessed shape that recedes upstream in the airflow, the rear edge portion has an outline represented by a rear-edge projected portion having a second recess portion formed in a recessed shape that recedes upstream in the airflow, and the first recess portion has at least a portion that is formed further radially inside than is the second recess portion.

### TECHNICAL FIELD

The present disclosure relates to an axial fan including blades, an air-sending device including the axial fan, and a refrigeration cycle apparatus including the air-sending device.

### BACKGROUND ART

Axial fans typically include blades disposed along the circumferential surface of a cylindrical boss. A torque provided to the boss causes the blades to rotate to thereby transport fluid. As the blades of such an axial fan rotate, the fluid existing between the blades strikes the surface of the blades. The surface struck by the fluid increases in pressure, which causes the fluid to be pushed out and move in the direction of a rotation axis about which the blades rotate.

To reduce required fan input relative to the related art, some proposed axial fans of this type are designed to have a protrusion disposed on the pressure surface, which scoops up airflow, of each blade in a direction transverse to the centrifugal direction (see, for example, Patent Literature 1).

### CITATION LIST

### Patent Literature

Patent Literature 1: Japanese Unexamined Patent Application Publication No. 2016-056772

### SUMMARY OF INVENTION

### Technical Problem

In the axial fan described in Patent Literature 1, the normal to the fan surface is directed outward in the outer area of each blade. Airflow is thus pushed out toward the outer area of the blade as the airflow moves from the front edge to the rear edge in the direction of rotation. The axial fan described in Patent Literature 1, however, has no structure provided at the outer end of the blade to prevent leakage of airflow. This means that as airflow moves along the pressure surface of the blade from the front edge toward the rear edge, a large proportion of the airflow leaks out of the blade from the outer edge of the blade. Therefore, the axial fan described in Patent Literature 1 does not allow the airflow received at the front edge of the blade to easily flow, in the direction of rotation of the blade, through the outer area of the pressure surface where force is efficiently imparted from the blade to the airflow.

The present disclosure aims to address the above-mentioned problem. Accordingly, it is an object of the present disclosure to provide an axial fan that allows the airflow received at the front edge of each blade to easily flow, in the direction of rotation of the blade, through the outer area of the pressure surface where force is efficiently imparted from the blade to the airflow, an air-sending device including the axial fan, and a refrigeration cycle apparatus including the air-sending device.

### Solution to Problem

An axial fan according to an embodiment of the present disclosure includes a hub and blades. The hub has a rotating shaft, and is configured to be driven to rotate. The blades are provided to the hub, and each have a front edge portion and a rear edge portion. In a state in which the blades rotate to generate an airflow, the front edge portion is placed most upstream in the airflow, and the rear edge portion is placed most downstream in the airflow. In a shape of the blades rotated and projected onto a meridian plane that covers shapes of the blades and a shape of the rotating shaft, the front edge portion has an outline represented by a front-edge projected portion having a first recess portion formed in a recessed shape that recedes upstream in the airflow, the rear edge portion has an outline represented by a rear-edge projected portion having a second recess portion formed in a recessed shape that recedes upstream in the airflow, and the first recess portion has at least a portion that is formed further radially inside than is the second recess portion.

An air-sending device according to an embodiment of the present disclosure includes the axial fan configured as described above, a drive source configured to provide a drive force to the axial fan, and a casing that accommodates the axial fan and the drive source,

A refrigeration cycle apparatus according to an embodiment of the present disclosure includes the air-sending device configured as described above, and a refrigerant circuit having a condenser and an evaporator. The air-sending device is configured to send air to at least one of the condenser and the evaporator.

### Advantageous Effects of Invention

According to an embodiment of the present disclosure, the second recess portion of the rear-edge projected portion is formed further radially outside than is the first recess portion of the front-edge projected portion, and the first recess portion has at least a portion that is formed further radially inside than is the second recess portion. As a result, the airflow along the pressure surface of each blade is directed radially outward as the airflow proceeds from the first recess portion of the front edge portion toward the second recess portion of the rear edge portion. This allows the airflow received at the front edge of the blade to easily flow, in the direction of blade rotation, through the outer area of the pressure surface where force is efficiently imparted from the blade to the airflow.

### BRIEF DESCRIPTION OF DRAWINGS

FIG. 1 is a schematic perspective view of an axial fan according to Embodiment 1.

FIG. 2 illustrates an exemplary shape of the axial fan according to Embodiment 1 that is rotated and projected onto a meridian plane MP depicted in FIG. 1

FIG. 3 illustrates another exemplary shape of the axial fan according to Embodiment 1 that is rotated and projected onto the meridian plane MP depicted in FIG. 1.

FIG. 4 is a perspective view of the axial fan according to Embodiment 1 for specifying various cross-section locations in the axial fan.

FIG. 5 illustrates cross-section locations A, B, and C in the axial fan depicted in FIG. 4 that are rotated and projected onto the meridian plane MP.

FIG. 6 illustrates respective cross-sections of a blade taken at the cross-section locations A, B, and C, as viewed in a direction perpendicular to a rotating shaft RS.

FIG. 7 illustrates an exemplary end face of a blade as viewed in the direction perpendicular to the rotating shaft RS.

FIG. 8 is a perspective view of a recessed passage of the axial fan according to Embodiment 1.

FIG. 9 illustrates a meridian plane schematically showing airflow through a blade of the axial fan according to Embodiment 1.

FIG. 10 illustrates a meridian plane schematically showing airflow through a blade of the axial fan according to a modification of Embodiment 1.

FIG. 11 illustrates an exemplary shape of an axial fan according to Embodiment 2 that is rotated and projected onto a meridian plane.

FIG. 12 illustrates an exemplary shape of an axial fan according to Embodiment 3 that is rotated and projected onto a meridian plane.

FIG. 13 illustrates an exemplary shape of an axial fan according to Embodiment 4 that is rotated and projected onto a meridian plane.

FIG. 14 is a schematic perspective view of an axial fan according to Embodiment 5.

FIG. 15 illustrates an exemplary shape of an axial fan according to Embodiment 6 that is rotated and projected onto a meridian plane.

FIG. 16 illustrates an exemplary shape of an axial fan according to Embodiment 7 that is rotated and projected onto a meridian plane.

FIG. 17 is a perspective view of an axial fan according to a comparative example, illustrating how airflow blows from the axial fan.

FIG. 18 is a perspective view of the axial fan according to Embodiment 7, illustrating how airflow blows from the axial fan.

FIG. 19 is a schematic perspective view of an axial fan according to Embodiment 8.

FIG. 20 is a schematic perspective view of an axial fan according to Embodiment 9.

FIG. 21 is a schematic diagram of a refrigeration cycle apparatus according to Embodiment 10.

FIG. 22 is a perspective view, as seen from an air outlet, of an outdoor unit used as an air-sending device.

FIG. 23 is a top view of an outdoor unit for explaining the configuration of the outdoor unit.

FIG. 24 illustrates the outdoor unit with a fan grille removed from the outdoor unit.

FIG. 25 illustrates the internal configuration of the outdoor unit with the fan grille, a front panel, and other components removed from the outdoor unit.

### DESCRIPTION OF EMBODIMENTS

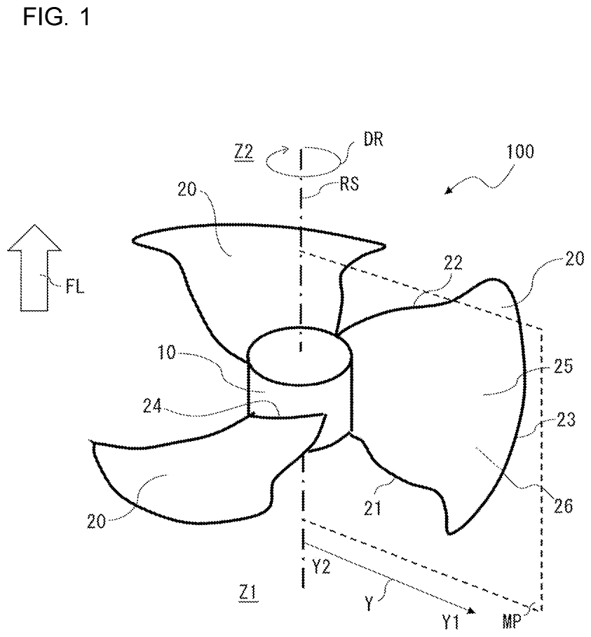

An axial fan, an air-sending device, and a refrigeration cycle apparatus according to embodiments will be described below with reference to the drawings. In the drawings below including FIG. 1, the relative dimensions, shapes, and other details of various components may differ from the actuality. In the drawings below, the same reference signs are used to indicate the same or corresponding elements or features throughout the specification. Although terms representing directions (e.g., “upper”, “lower”, “right”, “left”, “front”, or “rear”) are used as appropriate to facilitate understanding, such terms are for illustrative purposes only and not intended to limit the corresponding apparatus, device, or component to any particular placement or orientation.

### Embodiment 1

### [Axial Fan 100]

FIG. 1 is a schematic perspective view of an axial fan 100 according to Embodiment 1. A rotation direction DR represented by an arrow in FIG. 1 represents the direction of rotation DR of the axial fan 100. An open arrow in FIG. 1 represents the direction of airflow FL. In the direction of airflow FL, with the axial fan 100 used as positional reference, Z1 represents an area located upstream in the airflow with the axial fan 100 used as positional reference, and Z2 represents an area located downstream in the airflow with the axial fan 100 used as positional reference. That is, Z1 represents the air suction side with the axial fan 100 used as positional reference, and Z2 represents the air blow side with the axial fan 100 used as positional reference. The Y-axis represents radial direction from a rotating shaft RS of the axial fan 100. With the axial fan 100 used as positional reference, Y2 represents the radially inner area (to be referred to simply as “inner area” hereinafter) of the axial fan 100, and Y1 represents the radially outer area (to be referred to simply as “outer area” hereinafter) of the axial fan 100.

The axial fan according to Embodiment 1 is described below with reference to FIG. 1. The axial fan 100 is used for, for example, an air-conditioning apparatus or a ventilator. As illustrated in FIG. 1, the axial fan 100 includes a hub 10 disposed on the rotating shaft RS, and blades 20 provided to the hub 10.

### (Hub 10)

The hub 10 is driven to rotate, and defines the rotating shaft RS. The hub 10 rotates about the rotating shaft RS. The rotation direction DR of the axial fan 100 is a clockwise direction indicated by an arrow in FIG. 1. However, the rotation direction DR of the axial fan 100 may not necessarily be the clockwise direction. Alternatively, the axial fan 100 may be configured to rotate in a counterclockwise direction by changing the angle at which the blades 20 are mounted. The hub 10 is connected to the rotating shaft of a drive source such as a motor (not illustrated). In one example, the hub 10 may have a cylindrical shape, or may have a plate-like shape. The hub 10 is not limited to any particular shape as long as the hub 10 is connected to the rotating shaft of the drive source as mentioned above.

### (Blades 20)

The blades 20 extend radially outward from the hub 10, The blades 20 are circumferentially spaced apart from each other. Although Embodiment 1 is directed to an exemplary case where there are three blades 20, the number of blades 20 is not limited to three. In the direction of airflow FL, the upstream surface (surface near Z1) of each blade 20 is referred to as suction surface 26, and the downstream surface (surface near Z2) of the blade 20 is referred to as pressure surface 25. A surface of the blade 20 depicted on the near side of FIG. 1 corresponds to the pressure surface 25, and a surface of the blade 20 depicted on the far side of FIG. 1 corresponds to the suction surface 26.

The blade 20 has a front edge portion 21, a rear edge portion 22, an outer edge portion 23, and an inner edge portion 24. The front edge portion 21 is placed upstream (near Z1) in the airflow to be generated, and formed at the leading side of the blade 20 in the rotation direction DR. That is, the front edge portion 21 is placed forward of the rear edge portion 22 in the rotation direction DR. The rear edge portion 22 is placed downstream (near Z2) in the airflow to be generated, and formed at the trailing side of the blade 20 in the rotation direction DR. That is, the rear edge portion 22 is placed rearward of the front edge portion 21 in the rotation direction DR. The axial fan 100 has the front edge portion 21, which is a blade end portion oriented in the rotation direction DR of the axial fan 100, and the rear edge portion 22, which is a blade end portion opposite to the front edge portion 21 in the rotation direction DR.

The outer edge portion 23 extends in the front-rear direction and in arcuate form such that the outer edge portion 23 connects the outermost part of the front edge portion 21 with the outermost part of the rear edge portion 22. The outer edge portion 23 is located in an end portion of the axial fan 100 in the radial direction (Y-axis direction). The inner edge portion 24 extends in the front-rear direction and in arcuate form such that the inner edge portion 24 connects the innermost part of the front edge portion 21 with the innermost part of the rear edge portion 22. The inner edge portion 24 of the blade 20 is connected to the periphery of the hub 10.

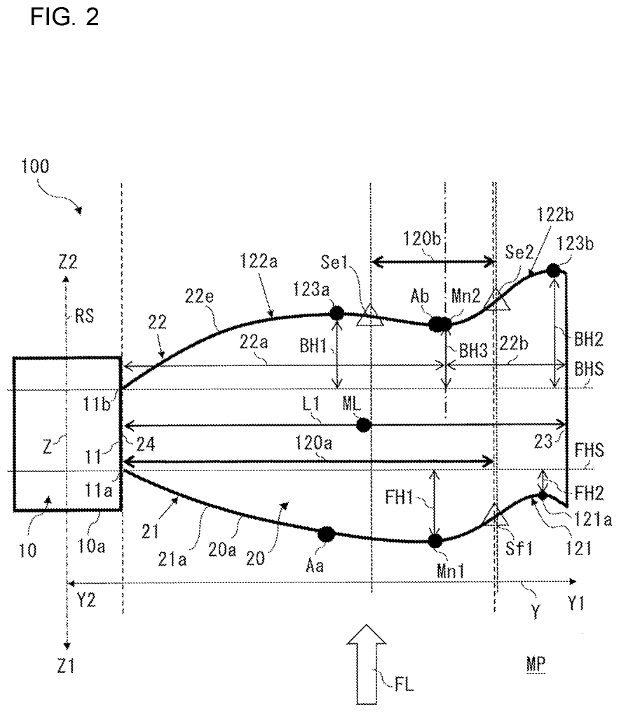

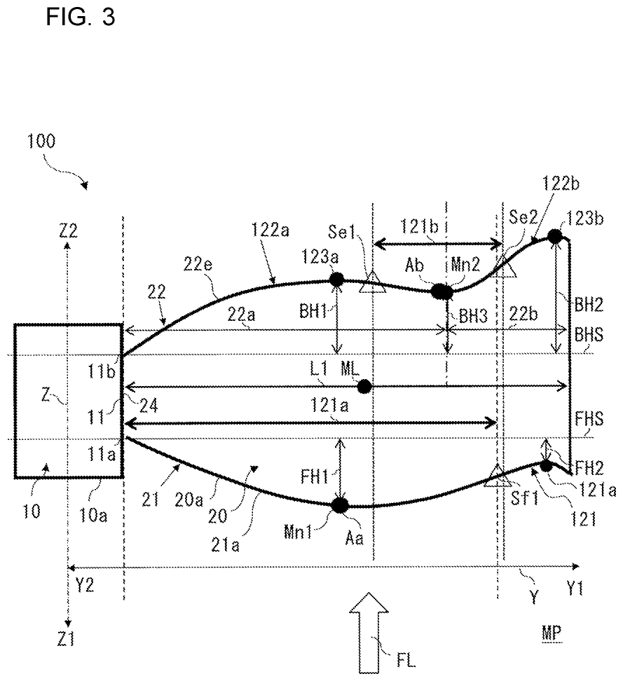

FIG. 2 illustrates an exemplary shape of the axial fan 100 according to Embodiment 1 that is rotated and projected onto a meridian plane MP depicted in FIG. 1. FIG. 3 illustrates another exemplary shape of the axial fan 100 according to Embodiment 1 that is rotated and projected onto the meridian plane MP depicted in FIG. 1. FIGS. 2 and 3 each illustrate a shape of each blade 20 of the axial fan 100 rotated and projected onto the meridian plane MP that covers the shape of the rotating shaft RS and the shapes of the blades 20. For the axial fan 100, a shape of each blade 20 that is rotated and projected onto the meridian plane MP is represented by a blade projected portion 20a, and a shape of the hub 10 that is rotated and projected onto the meridian plane MP is represented by a hub projected portion 10a.

As illustrated in FIGS. 2 and 3, in the meridian plane MP in which the horizontal axis represented by the Y-axis is defined as radial direction, and the vertical axis represented by the Z-axis is defined as the axial direction of the rotating shaft RS, the front edge portion 21 is located below the rear edge portion 22, and the rear edge portion 22 is located above the front edge portion 21, The front edge portion 21 and the rear edge portion 22 are each defined by a curve connecting a base portion 11, which is the root joint of the blade 20 with the hub 10, and the outer edge portion 23.

### (Front Edge Portion 21)

The front edge portion 21 defines, in the meridian plane MP onto which the front edge portion 21 is rotated and projected, a front-edge projected portion 21a formed by a curve including an S-shaped portion. The front-edge projected portion 21a is formed by an S-shaped curve that arcs upstream (toward Z1) and downstream (toward Z2) with the axial fan 100 used as positional reference.

The front-edge projected portion 21a has a front edge inflection-point portion Sf1, which is a point of inflection of the S-shape. In a direction perpendicular to the rotating shaft RS, that is, in the radial direction of the axial fan 100, the front edge inflection-point portion Sf1 is formed closer to the outer edge portion 23 than is the middle position ML of a straight line L1, which connects the hub 10 and the outer edge portion 23.

### (Front-Edge Recess Portion 120a)

The front edge portion 21 has a front-edge recess portion 120a. In the outline of the front edge portion 21 represented by the front-edge projected portion 21a, the front-edge recess portion 120a is formed in a protruding shape that protrudes upstream (toward Z1) in the airflow. As illustrated in FIGS. 2 and 3, the front edge portion 21 has an outline represented by the front-edge projected portion 21a that has the front-edge recess portion 120a formed in a protruding shape that protrudes upstream in the airflow.

The front-edge recess portion 120a corresponds to a first recess portion of the axial fan 100. In the front-edge projected portion 21a, the front-edge recess portion 120a is formed between a front-edge base portion 11a, which is the root joint of the front edge portion 21 with the hub 10, and the front edge inflection-point portion Sf1. In the front-edge projected portion 21a, the front-edge recess portion 120a forms an arc that protrudes upstream (toward Z1). In other words, in the front-edge recess portion 120a of the front edge portion 21, the pressure surface 25 forms an arc that recedes upstream (toward Z1). That is, in the front-edge recess portion 120a, the pressure surface 25 is formed in a recessed shape that opens downstream (toward Z2). In the front-edge recess portion 120a of the front edge portion 21, the suction surface 26 forms an arc that protrudes upstream (toward Z1).

The front edge portion 21 further has a front-edge ridge portion 121. In the front-edge projected portion 21a, the front-edge ridge portion 121 is formed so as to recede downstream (toward Z2). As illustrated in FIGS. 2 and 3, the front-edge projected portion 21a has the front-edge ridge portion 121 that recedes downstream (toward Z2). In the front-edge projected portion 21a, the front-edge ridge portion 121 forms an arc that recedes downstream (toward Z2). In other words, in the front-edge ridge portion 121 of the front edge portion 21, the pressure surface 25 forms an arc that protrudes downstream (toward Z2). That is, in the front-edge ridge portion 121 of the front edge portion 21, the suction surface 26 is formed in a recessed shape that opens upstream (toward Z1).

In the front-edge projected portion 21a, the front-edge recess portion 120a and the front-edge ridge portion 121 are formed in this order from the inner area toward the outer area in the radial direction of the axial fan 100. The front-edge projected portion 21a has, in the radial direction, a proportion of the front-edge recess portion 120a corresponding to the first recess portion that is greater than a proportion of the front-edge ridge portion 121. In other words, the front-edge projected portion 21a has, in the radial direction, a proportion of the front-edge recess portion 120a corresponding to the first recess portion that is greater than a proportion of a portion formed in a recessed shape that recedes downstream in the airflow.

A first plane FHS is now defined as an imaginary plane perpendicular to the rotating shaft RS and passing through the front-edge base portion 11a, which is the root joint of the front edge portion 21 with the hub 10. A point on the front-edge ridge portion 121 located closest to the first plane FHS is defined as a maximum-point portion 121a. The maximum-point portion 121a is located most downstream in the front-edge ridge portion 121. In the direction perpendicular to the rotating shaft RS, that is, in the radial direction of the axial fan 100, the maximum-point portion 121a is formed closer to the outer edge portion 23 than is the middle position ML of the straight line L1, which connects the hub 10 and the outer edge portion 23.

As illustrated in FIGS. 2 and 3, the front-edge recess portion 120a is formed further inside than is the maximum-point portion 121a. A point on the front-edge recess portion 120a located farthest from the first plane FHS is defined as a front edge minimum-point portion Mn1. The front edge minimum-point portion Mn1 corresponds to a first minimum-point portion of the axial fan 100. The front edge minimum-point portion Mill is located further upstream (toward Z2) than is the maximum-point portion 121a. The front edge minimum-point portion Mn1 corresponding to the first minimum-point portion is located at a position on the front-edge recess portion 120a that is most upstream (toward Z1) in the airflow. The distance FH1 between the first plane FHS and the front edge minimum-point portion Mn1 is greater than the distance FH2 between the first plane FHS and the maximum-point portion 121a.

### (Rear Edge Portion 22)

The rear edge portion 22 defines, in the meridian plane MP onto which the rear edge portion 22 is rotated and projected, a rear-edge projected portion 22e formed by a curve including S-shaped portions. The rear-edge projected portion 22e has a first S-shaped portion 22a, and a second S-shaped portion 22b. The first S-shaped portion 22a and the second S-shaped portion 22b of the rear-edge projected portion 22e are each formed by an S-shaped curve that arcs upstream (toward Z1) and downstream (toward Z2) in the airflow. The rear-edge projected portion 22e is formed by a curve that is a combination of the first S-shaped portion 22a and the second S-shaped portion 22b.

The rear-edge projected portion 22e has a rear edge first-inflection-point portion Se1, which is a point of inflection of the first S-shaped portion 22a, and a rear edge second-inflection-point portion Set, which is a point of inflection of the second S-shaped portion 22b. In the direction perpendicular to the rotating shaft RS, that is, in the radial direction of the axial fan 100, the rear edge second-inflection-point portion Se2 is formed closer to the outer edge portion 23 than is the middle position ML of the straight line L1, which connects the hub 10 and the outer edge portion 23. In the direction perpendicular to the rotating shaft RS, that is, in the radial direction of the axial fan 100, the rear edge first-inflection-point portion Set is formed further inside than is the rear edge second-inflection-point portion Se2.

### (Rear Edge Recess Portion 120b)

The rear edge portion 22 has a rear-edge recess portion 120b. The rear-edge recess portion 120b is formed in a recessed shape that recedes upstream in the airflow. As illustrated in FIGS. 2 and 3, the rear edge portion 22 has an outline represented by the rear-edge projected portion 22e that has the rear-edge recess portion 120b formed in a recessed shape that recedes upstream (toward Z1) in the airflow. The rear-edge recess portion 120b corresponds to a second recess portion of the axial fan 100. In the rear-edge projected portion 22e, the rear-edge recess portion 120b is formed between the rear edge first-inflection-point portion Set and the rear edge second-inflection-point portion Se2. In the rear-edge projected portion 22e, the rear-edge recess portion 120b forms an arc that recedes upstream (toward Z1). In other words, in the rear-edge recess portion 120b of the rear edge portion 22, the pressure surface 25 forms an arc that recedes upstream (toward Z1). That is, in the rear-edge recess portion 120b the pressure surface 25 is formed in a recessed shape that opens downstream (toward Z2). In the rear-edge recess portion 120b of the rear edge portion 22, the suction surface 26 forms an arc that protrudes upstream (toward Z1).

The rear edge portion 22 further has a first ridge portion 122a, and a second ridge portion 122b. The first ridge portion 122a and the second ridge portion 122b are formed so as to protrude downstream (toward Z2). As illustrated in FIGS. 2 and 3, the rear-edge projected portion 22e has the first ridge portion 122a that forms an arc protruding downstream (toward Z2), The rear-edge projected portion 22e has the second ridge portion 122b that forms an arc protruding downstream (toward Z2). In the front-edge projected portion 21a, the first ridge portion 122a and the second ridge portion 122b each form an arc that protrudes downstream (toward Z2). In other words, in the first ridge portion 122a and the second ridge portion 122b of the rear edge portion 22, the pressure surface 25 forms an arc that protrudes downstream (toward Z2). That is, in the first ridge portion 122a and the second ridge portion 122b of the rear edge portion 22, the suction surface 26 is formed in a recessed shape that opens upstream (toward Z1). The rear-edge recess portion 120b is formed between the first ridge portion 122a and the second ridge portion 122b. In the rear-edge projected portion 22e, the first ridge portion 122a, the rear-edge recess portion 120b, and the second ridge portion 122b are formed in this order from the inner area toward the outer area in the radial direction of the axial fan 100.

A second plane BHS is now defined as an imaginary plane perpendicular to the rotating shaft RS and passing through a rear-edge base portion 11b, which is the root joint of the rear edge portion 22 with the hub 10. A point on the first ridge portion 122a located farthest from the second plane BHS is defined as a first maximum-point portion 123a. The first maximum-point portion 123a is located most downstream in the first ridge portion 122a, Likewise, a point on the second ridge portion 122b located farthest from the second plane BHS is defined as a second maximum-point portion 123b. The second maximum-point portion 123b is located most downstream in the second ridge portion 122b. The distance BH2 between the second plane BHS and the second maximum-point portion 123b is greater than the distance BH1 between the second plane BHS and the first maximum-point portion 123a. That is, the distance BH1 between the second plane BHS and the first maximum-point portion 123a is less than the distance BH2 between the second plane BHS and the second maximum-point portion 123b. The second maximum-point portion 123b is located further downstream (toward Z2) than is the first maximum-point portion 123a. In the direction perpendicular to the rotating shaft RS, that is, in the radial direction of the axial fan 100, the second maximum-point portion 123b is formed closer to the outer edge portion 23 than is the middle position ML of the straight line L1, which connects the hub 10 and the outer edge portion 23.

As illustrated in FIGS. 2 and 3, the rear-edge recess portion 120b is formed between the first maximum-point portion 123a and the second maximum-point portion 123b. A point on the rear-edge recess portion 120b located closest to the second plane BHS is defined as a rear edge minimum-point portion Mn2. The rear edge minimum-point portion Mn2 corresponds to a second minimum-point portion of the axial fan 100. The rear edge minimum-point portion Mn2 corresponding to the second minimum-point portion is located at a position on the rear-edge recess portion 120b that is most upstream (toward Z1) in the airflow. The rear edge minimum-point portion Mn2 is located further upstream (toward Z1) than are the first maximum-point portion 123a and the second maximum-point portion 123b. The distance BH3 between the second plane BHS and the rear edge minimum-point portion Mn2 is less than the distance BH1 between the second plane BHS and the first maximum-point portion 123a. The distance BH3 between the second plane BHS and the rear edge minimum-point portion Mn2 is less than the distance BH2 between the second plane BHS and the second maximum-point portion 123b.

As illustrated in FIGS. 2 and 3, the rear-edge recess portion 120b, which corresponds to the second recess portion of the axial fan 100, is formed radially closer to the outer edge portion 23 than is the front-edge recess portion 120a, which corresponds to the first recess portion of the axial fan 100. The front-edge recess portion 120a, which corresponds to the first recess portion of the axial fan 100, has at least a portion that is formed closer to the inner edge portion 24 than is the rear-edge recess portion 120b, which corresponds to the second recess portion of the axial fan 100.

The middle position of the radial width of the front-edge recess portion 120a is now defined as a front-edge-side middle portion Aa. That is, in the radial direction of the axial fan 100, the midpoint of the distance between the front-edge base portion 11a and the front edge inflection-point portion Sf1 is defined as the front-edge-side middle portion Aa. The middle position of the radial width of the rear-edge recess portion 120b is defined as a rear-edge-side middle portion Ab. That is, in the radial direction of the axial fan 100, the midpoint of the distance between the rear edge first-inflection-point portion Set and the rear edge second-inflection-point portion Set is defined as the rear-edge-side middle portion Ab. As illustrated in FIGS. 2 and 3, in the radial direction of the axial fan 100, the rear-edge-side middle portion Ab is located further outside than is the front-edge-side middle portion Aa. In one example, the front-edge-side middle portion Aa may be different from the front edge minimum-point portion Mn1 as illustrated in FIG. 2, and in another example, the front-edge-side middle portion Aa may be the same as the front edge minimum-point portion Mn1 as illustrated in FIG. 3.

(Relationship between Meridian Plane, and Front-Edge Recess Portion 120a and Rear-Edge Recess Portion 120b)

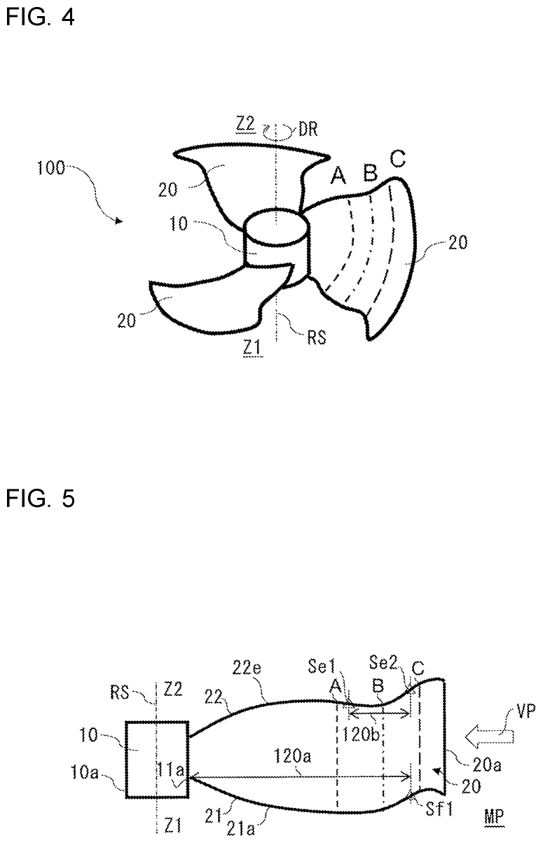

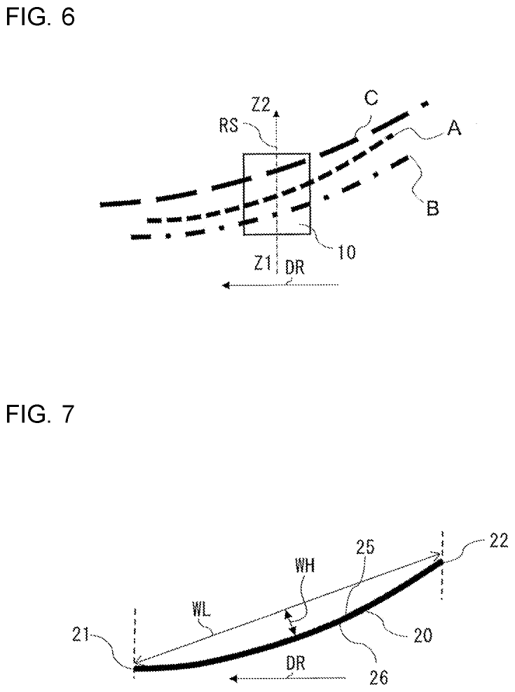

FIG. 4 is a perspective view of the axial fan 100 according to Embodiment 1 for specifying various cross-section locations in the axial fan 100. A cross-section location A, a cross-section location B, and a cross-section location C depicted in FIG. 4 each represent a location at which the corresponding cross-section of the blade 20 is taken in the rotation direction DR. FIG. 5 illustrates the cross-section locations A, B, and C in the axial fan 100 depicted in FIG. 4 that are rotated and projected onto the meridian plane MP. FIG. 6 illustrates respective cross-sections of the blade 20 taken at the cross-section locations A, B, and C, as viewed in the direction perpendicular to the rotating shaft RS. FIG. 7 illustrates an exemplary end face of the blade 20 as viewed in the direction perpendicular to the rotating shaft RS. The expression “as viewed in the direction perpendicular to the rotating shaft RS” means being viewed in a direction indicated by an open arrow VP in FIG. 5. The relationship between the meridian plane, and the front-edge recess portion 120a and the rear-edge recess portion 120b is described below with reference to FIGS. 4 to 7.

As illustrated in FIGS. 4 to 7, the blade 20 is sloped such that the front edge portion 21 is located upstream (toward Z1) in the airflow, and that the rear edge portion 22 is located downstream (toward Z2) in the airflow. As illustrated in FIGS. 6 and 7, in the rotation direction OR, the blade 20 is cambered in an arc that recedes upstream (toward Z1) in the airflow. As illustrated in FIG. 7, a straight line connecting the front edge portion 21 and the rear edge portion 22 of the blade 20 is defined as chord length WL, and the distance between the chord length WL and the pressure surface 25 of the blade 20 is defined as camber height WH. As illustrated in FIG. 6, the blade cross-section taken at the cross-section location B is located most upstream (toward Z1) among the cross-sections of the blade 20 taken at the cross-section locations A, B, and C. That is, at the cross-section location B, the blade 20 is formed in a recessed shape that recedes from the cross-section location A and the cross-section location C. As illustrated in FIG. 6, the chord length WL of the blade 20 increases in the following order: the cross-section location A, the cross-section location B, and the cross-section location C. That is, in a portion of the blade 20 from the cross-section location A to the cross-section location C in the radial direction, the chord length WL progressively increases as the blade 20 extends outward. The above-mentioned relationship among the respective chord lengths WL at the cross-section locations A, B, and C is intended to be illustrative only and not limiting.

The front-edge recess portion 120a of the axial fan 100 can be defined in the meridian plane by the following features: the chord length WL and camber height WH of the blade 20 as illustrated in FIG. 7; and the locations in the front edge portion 21 such as the cross-section locations A, B, and C in the axial direction of the rotating shaft RS as illustrated in FIG. 6. The rear-edge recess portion 120b of the axial fan 100 can be defined in the meridian plane by the following features: the chord length WL and camber height WH of the blade 20 as illustrated in FIG. 7; and the locations in the rear edge portion 22 such as the cross-section locations A, B, and C in the axial direction of the rotating shaft RS as illustrated in FIG. 6.

### (Recessed Passage 120)

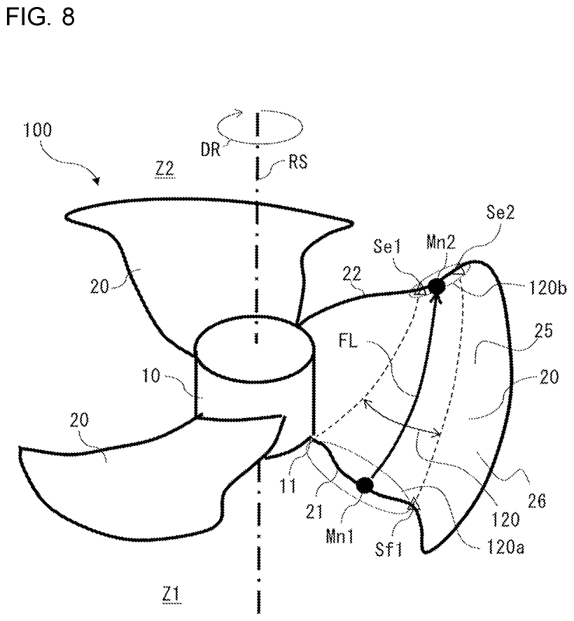

FIG. 8 is a perspective view of a recessed passage 120 of the axial fan 100 according to Embodiment 1. As illustrated in FIG. 8, the pressure surface 25 of the blade 20 has the recessed passage 120 formed in a recessed shape that recedes upstream (toward Z1) in the airflow. The recessed passage 120 defines, on the pressure surface 25 of the blade 20, a passage through which air flows. In the recessed passage 120, the pressure surface 25 is formed in a recessed shape that recedes upstream (toward Z1) in an arc in the radial direction of the axial fan 100. Further, in the recessed passage 120, the suction surface 26 is formed in a protruding shape that protrudes upstream (toward Z1) in an arc in the radial direction of the axial fan 100. That is, a wall of the blade 20 that defines the recessed passage 120 is curved so as to protrude upstream (toward Z1).

The recessed passage 120 is formed between the front edge portion 21 and the rear edge portion 22. The recessed passage 120 extends continuously from the front edge portion 21 to the rear edge portion 22 in the rotation direction DR of the axial fan 100. In the circumferential direction, the recessed passage 120 has an end portion near the front edge portion 21 that is defined by a portion of the recessed passage 120 that defines the front-edge recess portion 120a, and the recessed passage 120 has an end portion near the rear edge portion 22 that is defined by a portion of the recessed passage 120 that defines the rear-edge recess portion 120b. That is, the recessed passage 120 includes, in opposite end portions in the rotation direction DR of the axial fan 100, a portion defining the front-edge recess portion 120a and a portion defining the rear-edge recess portion 120b, and defines a passage through which airflow passes between the front-edge recess portion 120a and the rear-edge recess portion 120b.

### [Operation of Axial Fan 100]

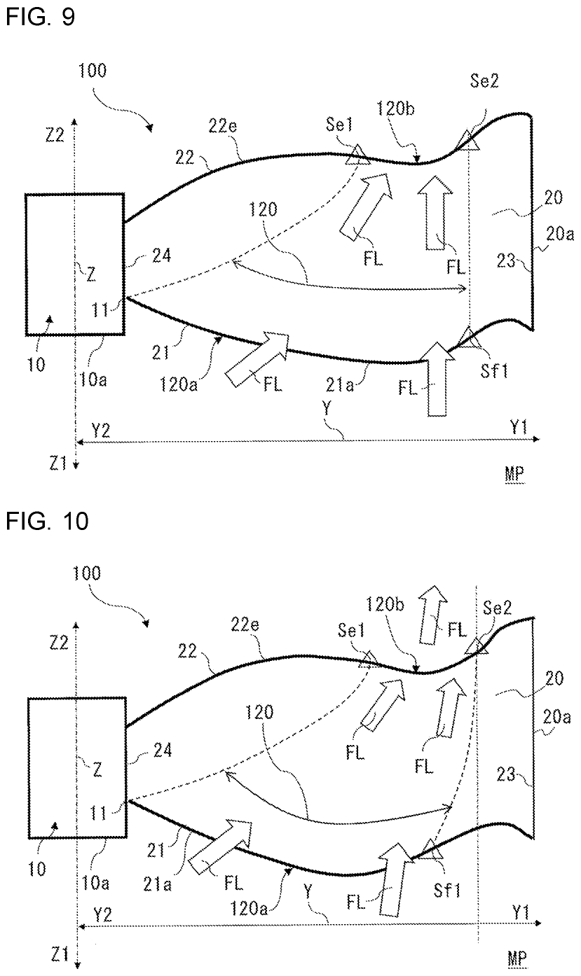

FIG. 9 illustrates a meridian plane schematically showing airflow through each blade 20 of the axial fan 100 according to Embodiment 1. The flow of air through the blade 20 of the axial fan 100 is described below with reference to FIGS. 8 and 9. The direction FL indicated by arrows represents the direction of airflow. As illustrated in FIG. 8, the recessed passage 120 is used as a passage for airflow on the pressure surface 25 of the blade 20. As the blade 20 rotates about the rotating shaft RS driven by a motor or another drive device coupled to the axial fan 100, the pressure surface 25 of the blade 20 receives air. Then, as illustrated in FIGS. 8 and 9, the airflow entering through the front-edge recess portion 120a of the front edge portion 21 passes through and moves along the recessed passage 120. At this time, the airflow is directed outward in the radial direction of the axial fan 100 as the airflow moves along the recessed passage 120 from the front-edge recess portion 120a of the front edge portion 21 toward the rear-edge recess portion 120b of the rear edge portion 22. Due to the movement of airflow from the inner area toward the outer area in the radial direction of the axial fan 100, energy resulting from a difference in angular momentum associated with a change in radius is provided from the blade 20 to the gas.

FIG. 10 illustrates a meridian plane schematically showing airflow through the blade 20 of the axial fan 100 according to a modification of Embodiment 1. In the axial fan 100 described above with reference to FIG. 9, the rear edge second-inflection-point portion Se2 and the front edge inflection-point portion Sf1 are located at substantially the same radial position from the rotating shaft RS. In contrast, in the axial fan 100 illustrated in FIG. 10, the rear edge second-inflection-point portion Se2 and the front edge inflection-point portion Sf1 are located at different radial positions from the rotating shaft RS. More specifically, in the axial fan 100 illustrated in FIG. 10, the front edge inflection-point portion Sf1 is located further radially inside, that is, closer to the rotating shaft RS, than is the rear edge second-inflection-point portion Set. The front edge inflection-point portion Sf1 is located radially between the rear edge first-inflection-point portion Set and the rear edge second-inflection-point portion Set. The axial fan 100 illustrated in FIG. 10 thus allows more airflow to be directed radially outward than does the axial fan 100 illustrated in FIG. 9. As a result, the energy resulting from a difference in angular momentum (=radius×momentum) associated with a change in radius is greater for the axial fan 100 illustrated in FIG. 10 than for the axial fan 100 illustrated in FIG. 9.

### [Advantageous Effects of Axial Fan 100]

In the axial fan 100, the rear-edge recess portion 120b corresponding to the second recess portion is formed further radially outside than is the front-edge recess portion 120a corresponding to the first recess portion, and the front-edge recess portion 120a has at least a portion that is formed further radially inside than is the rear-edge recess portion 120b. Consequently, the airflow along the pressure surface 25 of the blade 20 is directed radially outward as the airflow proceeds from the front-edge recess portion 120a of the front edge portion 21 toward the rear-edge recess portion 120b of the rear edge portion 22. In this regard, generally speaking, when an axial fan pushes out gas in the outer area of the blades, a greater moment is imparted to the gas from the blades for the same rotation frequency of the axial fan than a moment when the axial fan pushes out the gas in the inner area of the blades. It is therefore desired for an axial fan to direct airflow toward and through the outer area of the blades. The configuration of the axial fan 100 mentioned above allows the airflow received at the front edge portion 21 of the blade 20 to easily flow, in the direction of rotation of the blade 20, through the outer area of the pressure surface 25 where force is efficiently imparted from the blade 20 to the airflow. In this regard, gas flowing along the pressure surface 25 of the blade 20 of the axial fan 100 can obtain the energy of momentum due to movement of the gas from the inner area toward the outer area in the radial direction. This leads to increased flow rate. As a result, the axial fan 100 is able to efficiently send air, which leads to reduced power consumption.

The front-edge recess portion 120a is formed between the base portion 11, which is the root joint of the front edge portion 21 with the hub 10, and the front edge inflection-point portion Sf1. The rear-edge recess portion 120b is formed between the rear edge first-inflection-point portion Set and the rear edge second-inflection-point portion Set. Consequently, the airflow along the pressure surface 25 of the blade 20 is directed radially outward as the airflow proceeds from the front-edge recess portion 120a of the front edge portion 21 toward the rear-edge recess portion 120b of the rear edge portion 22. The configuration of the axial fan 100 mentioned above allows the airflow received at the front edge portion 21 of the blade 20 to easily flow, in the direction of rotation of the blade 20, through the outer area of the pressure surface 25 where force is efficiently imparted from the blade 20 to the airflow. In this regard, gas flowing along the pressure surface 25 of the blade 20 of the axial fan 100 can obtain the energy of momentum due to movement of the gas from the inner area toward the outer area in the radial direction. This leads to increased flow rate. As a result, the axial fan 100 is able to efficiently send air, which leads to reduced power consumption.

The front edge inflection-point portion Sf1 is located radially between the rear edge first-inflection-point portion Set and the rear edge second-inflection-point portion Set. Due to the above-mentioned configuration, the front edge portion 21 is located further inside than is the rear edge portion 22, The recessed passage 120 is thus formed in the pressure surface 25 such that the location of the recessed passage 120 moves from the inner area toward the outer area as the recessed passage 120 extends from the front edge portion 21 to the rear edge portion 22. This causes the airflow over the pressure surface 25 to move from the inner area toward the outer area as the airflow proceeds from the front edge portion 21 to the rear edge portion 22. The airflow is thus able to obtain the energy of momentum resulting from a difference in radius. This leads to increased flow rate. As a result, the axial fan 100 is able to efficiently send air, which leads to reduced power consumption.

The front-edge projected portion 21a has, in the radial direction, a proportion of the front-edge recess portion 120a corresponding to the first recess portion that is greater than a proportion of a portion formed in a recessed shape that recedes downstream in the airflow. The blade 20 of the axial fan 100 thus has a surface having a recessed shape (bowl-like shape) that recedes downstream. This makes it easier to scoop up airflow, which allows for increased airflow into the axial fan 100. The downwardly recessed shape helps to reduce the chances of leakage of airflow from the outer edge of the axial fan 100. This allows the airflow to be easily retained from the front edge portion 21 to the rear edge portion 22.

The recessed passage 120 is formed between the front edge portion 21 and the rear edge portion 22. In the circumferential direction, the recessed passage 120 has an end portion near the front edge portion 21 that is defined by a portion of the recessed passage 120 that defines the front-edge recess portion 120a, and the recessed passage 120 has an end portion near the rear edge portion 22 that is defined by a portion of the recessed passage 120 that defines the rear-edge recess portion 120b,

The configuration of the axial fan 100 mentioned above allows the airflow received at the front edge portion 21 of the blade 20 to easily flow, in the direction of rotation of the blade 20, through the outer area of the pressure surface 25 where force is efficiently imparted from the blade 20 to the airflow. In this regard, gas flowing along the pressure surface 25 of the blade 20 of the axial fan 100 can obtain the energy of momentum due to movement of the alas from the inner area toward the outer area in the radial direction. This leads to increased flow rate. As a result, the axial fan 100 is able to efficiently send air, which leads to reduced power consumption.

### Embodiment 2

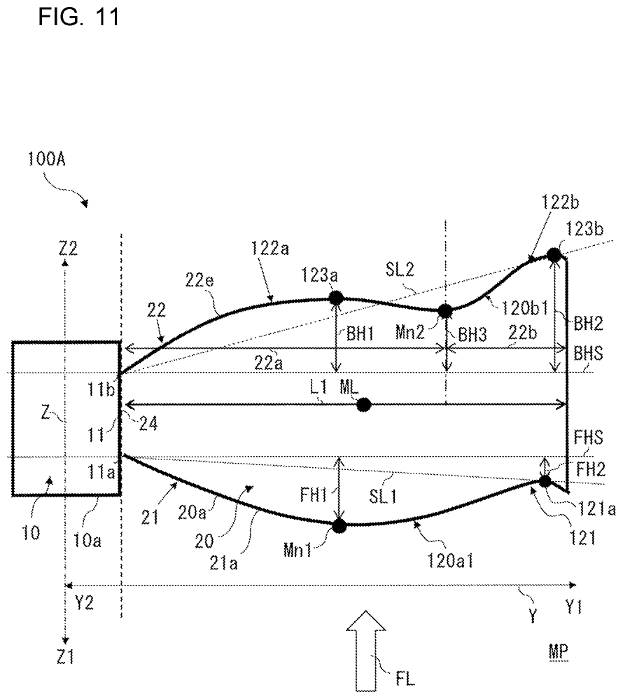

FIG. 11 illustrates an exemplary shape of an axial fan 100A according to Embodiment 2 that is rotated and projected onto a meridian plane. Parts identical in configuration to those of the axial fan 100A illustrated in FIGS. 1 to 10 are given the same reference signs and not described below in further detail. For the axial fan 100A according to Embodiment 2, a front-edge recess portion 120a1 and a rear-edge recess portion 120b1 differ in configuration from the front-edge recess portion 120a and the rear-edge recess portion 120b of the axial fan 100 according to Embodiment 1. The following description of the axial fan 100A according to Embodiment 2 will thus mainly focus on the configurations of the front-edge recess portion 120a1 and the rear-edge recess portion 120b1.

### (Front-Edge Recess Portion 120a1)

The front edge portion 21 has the front-edge recess portion 120a1. In an outline of the front edge portion 21 represented by the front-edge projected portion 21a, the front-edge recess portion 120a1 is formed in a protruding shape that protrudes upstream (toward Z1) in the airflow. As illustrated in FIG. 11, the front edge portion 21 has an outline represented by the front-edge projected portion 21a that has the front-edge recess portion 120a1 formed in a protruding shape that protrudes upstream in the airflow. The front-edge recess portion 120a1 corresponds to the first recess portion of the axial fan 100. In the front-edge projected portion 21a, the front-edge recess portion 120a1 forms an arc that protrudes upstream (toward Z1). In other words, in the front-edge recess portion 120a1 of the front edge portion 21, the pressure surface 25 forms an arc that recedes upstream (toward Z1). That is, in the front-edge recess portion 120a1, the pressure surface 25 is formed in a recessed shape that opens downstream (toward Z2). In the front-edge recess portion 120a1 of the front edge portion 21, the suction surface 26 forms an arc that protrudes upstream (toward Z1), The front-edge projected portion 21a has the front-edge ridge portion 121 that recedes downstream (toward Z2). In the front-edge projected portion 21a. the front-edge recess portion 120a1 and the front-edge ridge portion 121 are formed in this order from the inner area toward the outer area in the radial direction of the axial fan 100.

A straight line in the meridian plane that connects the front-edge base portion 11a, which is the root joint of the front edge portion 21 with the hub 10, and the maximum-point portion 121a is now defined as a straight line SL1. The front-edge recess portion 120a1 is a portion of the front-edge projected portion 21a that is located further upstream (toward Z1) than is the straight line SL1.

As illustrated in FIG. 11 the front-edge recess portion 120a1 is formed further inside than is the maximum-point portion 121a. A point on the front-edge recess portion 120a1 located farthest from the first plane FHS is defined as the front edge minimum-point portion Mn1. The front edge minimum-point portion Mn1 is located further upstream (toward Z2) than is the maximum-point portion 121a. The front edge minimum-point portion Mn1 is located most upstream (toward Z1) in the front-edge recess portion 120a1.

### (Rear-Edge Recess Portion 120b1)

The rear edge portion 22 has the rear-edge recess portion 120b1. The rear-edge recess portion 120b1 is formed in a recessed shape that recedes upstream in the airflow. As illustrated in FIG. 11, the rear edge portion 22 has an outline represented by the rear-edge projected portion 22e that has the rear-edge recess portion 120b1 formed in a recessed shape that recedes upstream (toward Z1) in the airflow. The rear-edge recess portion 120b1 corresponds to the second recess portion of the axial fan 100. In the rear-edge projected portion 22e, the rear-edge recess portion 120b1 forms an arc that recedes upstream (toward Z1). In other words, in the rear-edge recess portion 120b1 of the rear edge portion 22 the pressure surface 25 forms an arc that recedes upstream (toward Z1). That is, in the rear-edge recess portion 120b1, the pressure surface 25 is formed in a recessed shape that opens downstream (toward Z2). In the rear-edge recess portion 120b1 of the rear edge portion 22, the suction surface 26 forms an arc that protrudes upstream (toward Z1). The rear edge portion 22 further has the first ridge portion 122a, and the second ridge portion 122b. The first ridge portion 122a and the second ridge portion 122b are formed so as to protrude downstream (toward Z2). In the front-edge projected portion 21a, the first ridge portion 122a and the second ridge portion 122b each form an arc that protrudes downstream (toward Z2). The rear-edge recess portion 120b1 is formed between the first ridge portion 122a and the second ridge portion 122b. In the rear-edge projected portion 22e, the first ridge portion 122a, the rear-edge recess portion 120b1, and the second ridge portion 122b are formed in this order from the inner area toward the outer area in the radial direction of the axial fan 100.

A straight line in the meridian plane that connects the rear-edge base portion 11b, which is the root joint of the rear edge portion 22 with the hub 10, and the second maximum-point portion 123b is now defined as a straight line SL2. The rear-edge recess portion 120b1 is a portion of the rear-edge projected portion 22e that is located further upstream (toward Z1) than is the straight line SL2.

As illustrated in FIG. 11, the rear-edge recess portion 120b1 is formed between the first maximum-point portion 123a and the second maximum-point portion 123b. A point on the rear-edge recess portion 120b1 located closest to the second plane BHS is defined as the rear edge minimum-point portion Mn2. The rear edge minimum-point portion Mn2 is located further upstream (toward Z1) than are the first maximum-point portion 123a and the second maximum-point portion 123b. The rear edge minimum-point portion Mn2 is located most upstream (toward Z1) in the rear-edge recess portion 120b1.

As illustrated in FIG. 11, the rear-edge recess portion 120b1 of the rear-edge projected portion 22e is formed radially closer to the outer edge portion 23 than is the front-edge recess portion 120a1 of the front-edge projected portion 21a. The front-edge recess portion 120a1 of the front-edge projected portion 21a has a portion that is formed closer to the inner edge portion 24 than is the rear-edge recess portion 120b1 of the rear-edge projected portion 22e.

As with the axial fan 100, the axial fan 100A has the recessed passage 120 provided to the blade 20. The axial fan 100A has the front-edge recess portion 120a1 and the rear-edge recess portion 120b1 that are located at opposite ends of the recessed passage 120 in the rotation direction DR.

### [Advantageous Effects of Axial Fan 100A]

In the axial fan 100A, the rear-edge recess portion 120b1 corresponding to the second recess portion is formed further radially outside than is the front-edge recess portion 120a1 corresponding to the first recess portion, and the front-edge recess portion 120a1 has at least a portion that is formed further radially inside than is the rear-edge recess portion 120b1. Consequently, the airflow along the pressure surface 25 of the blade 20 is directed radially outward as the airflow proceeds from the front-edge recess portion 120a1 of the front edge portion 21 toward the rear-edge recess portion 120b1 of the rear edge portion 22. In this regard, generally speaking, when an axial fan pushes out gas in the outer area of the blades, a greater moment is imparted to the gas from the blades for the same rotation frequency of the axial fan than a moment when the axial fan pushes out the gas in the inner area of the blades. It is therefore desired for an axial fan to direct airflow toward and through the outer area of the blades.

The configuration of the axial fan 100A mentioned above allows the airflow received at the front edge portion 21 of the blade 20 to easily flow, in the direction of rotation of the blade 20, through the outer area of the pressure surface 25 where force is efficiently imparted from the blade 20 to the airflow. In this regard, gas flowing along the pressure surface 25 of the blade 20 of the axial fan 100A can obtain the energy of momentum due to movement of the alas from the inner area toward the outer area in the radial direction. This leads to increased flow rate. As a result, the axial fan 100A is able to efficiently send air, which leads to reduced power consumption.

### Embodiment 3

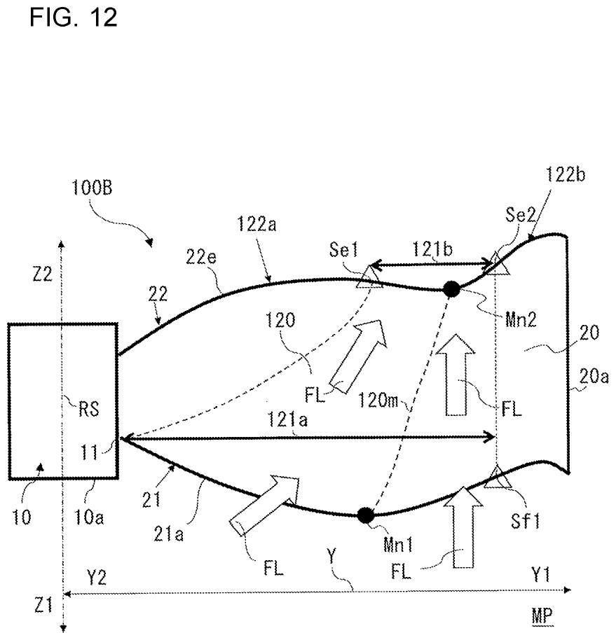

FIG. 12 illustrates an exemplary shape of an axial fan 100B according to Embodiment 3 that is rotated and projected onto a meridian plane. Parts identical in configuration to those of the axial fan 100 or other axial fans illustrated in FIGS. 1 to 11 are given the same reference signs and not described below in further detail. For the axial fan 100E according to Embodiment 3, the configurations of the front-edge recess portion 120a and the rear-edge recess portion 120b, as well as the configurations of the front-edge recess portion 120a1 and the rear-edge recess portion 120b1 are further specified.

### (Configuration of Axial Fan 1008)

As illustrated in FIG. 12, in the radial direction of the axial fan 1003, the rear edge minimum-point portion Mn2 corresponding to the second minimum-point portion is formed further outside than is the front edge minimum-point portion Mn1 corresponding to the first minimum-point portion. That is, in the direction perpendicular to the rotating shaft RS, the distance between the rotating shaft RS and the rear edge minimum-point portion Mn2 is greater than the distance between the rotating shaft RS and the front edge minimum-point portion Mn1.

A minimum-point portion 120m, which includes the front edge minimum-point portion Mn1 and the rear edge minimum-point portion Mn2, is a portion of the recessed passage 120 with the greatest elevation difference on the pressure surface 25 of the blade 20 in the axial direction of the rotating shaft RS. That is, the minimum-point portion 120m is a portion of the recessed passage 120 where airflow tends to concentrate. The minimum-point portion 120m is defined as the most upstream portions of respective cross-sections of the recessed passage 120 in the axial direction.

The minimum-point portion 120m is also defined as a continuation, between the front edge portion 21 and the rear edge portion 22, of the respective most upstream portions of the cross-sections of the recessed passage 120 in the axial direction.

### (Operational Effects of Axial Fan 1003)

In the axial fan 100B, the rear edge minimum-point portion Mn2 is located further outside than is the front edge minimum-point portion Mn1 in the radial direction of the axial fan 100B, This allows more airflow to be directed outward in the radial direction of the axial fan 1003 as the airflow proceeds from the front edge portion 21 toward the rear edge portion 22. When an airflow is directed from the inner area toward the outer area in the radial direction as the airflow moves from the front edge portion 21 to the rear edge portion 22, this makes it easier for a greater portion of the airflow to obtain the energy of momentum due to movement of the airflow from the inner area toward the outer area in the radial direction, in comparison to an airflow that moves circumferentially along the pressure surface 25 of the axial fan 100. In this regard, gas flowing along the pressure surface 25 of the blade 20 of the axial fan 100E can obtain the energy of momentum due to movement of the gas from the inner area toward the outer area in the radial direction. This leads to increased flow rate. As a result, the axial fan 100E is able to efficiently send air, which leads to reduced power consumption.

### Embodiment 4

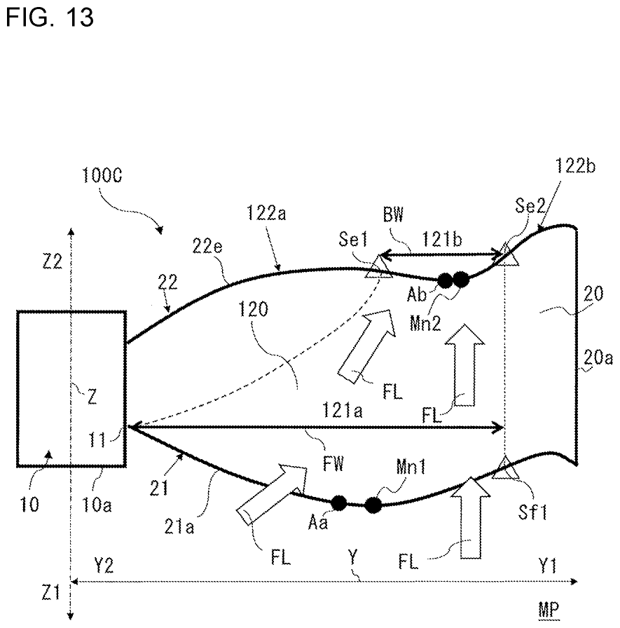

FIG. 13 illustrates an exemplary shape of an axial fan 1000 according to Embodiment 4 that is rotated and projected onto a meridian plane. Parts identical in configuration to those of the axial fan 100 or other axial fans illustrated in FIGS. 1 to 12 are given the same reference signs and not described below in further detail. For the axial fan 1000 according to Embodiment 4, the configurations of the front-edge recess portion 120a and the rear-edge recess portion 120b, as well as the configurations of the front-edge recess portion 120a1 and the rear-edge recess portion 120b1 are further specified. Although the configurations of the front-edge recess portion 120a and the rear-edge recess portion 120b are described below, the configurations of the front-edge recess portion 120a1 and the rear-edge recess portion 120b1 are identical to the configurations of the front-edge recess portion 120a and the rear-edge recess portion 120b, and thus are not described below in further detail.

### (Configuration of Axial Fan 1000)

As illustrated in FIG. 13, the rear-edge recess portion 120b corresponding to the second recess portion of the blade 20 of the axial fan 1000 has a radial width BW less than the radial width FW of the front-edge recess portion 120a corresponding to the first recess portion. The airflow passes through the blade 20 along the recessed passage 120 as described below. In the front-edge projected portion 21a, the airflow enters through the front-edge recess portion 120a centered at the front-edge-side middle portion As and having a large radial width. Then, as the airflow moves toward the rear edge portion 22, the airflow concentrates toward the rear-edge recess portion 120b centered at the rear-edge-side middle portion Ab and having a small radial width.

### (Operational Effects of Axial Fan 1000)

The axial fan 1000 allows airflow to enter through a radially wide portion of the blade 20, and then allows the incoming gas to concentrate so as to pass through the outer area of the blade 20 where a large force is imparted from the blade 20 to the airflow. Consequently, energy can be efficiently imparted to the airflow. This allows the axial fan 1000 to efficiently provide large airflow.

### Embodiment 5

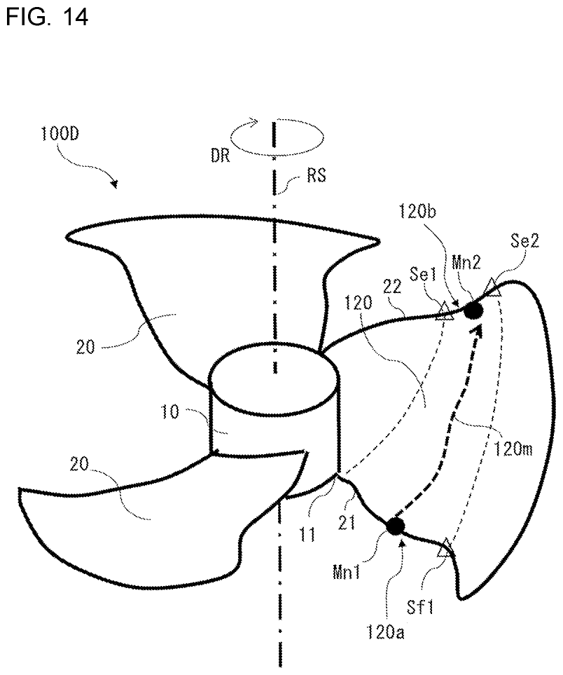

FIG. 14 is a schematic perspective view of an axial fan 100D according to Embodiment 5. Parts identical in configuration to those of the axial fan 100 or other axial fans illustrated in FIGS. 1 to 13 are given the same reference signs and not described below in further detail. For the axial fan 1000 according to Embodiment 5, the configuration of the recessed passage 120 is further specified.

### (Configuration of Axial Fan 1001)

As described above, the minimum-point portion 120m is defined as the most upstream portions of respective cross-sections of the recessed passage 120 in the radial direction. The minimum-point portion 120m is also defined as a continuation, between the front edge portion 21 and the rear edge portion 22, of the most upstream portions of the cross-sections of the recessed passage 120 in the radial direction. In the axial fan 100D according to Embodiment 5, the minimum-point portion 120m of the recessed passage 120 is formed at a location that moves radially outward as the minimum-point portion 120m extends from the front edge portion 21 to the rear edge portion 22. In determining where to form the minimum-point portion 120m, consideration is given to the balance between the flow rate of airflow suctioned from the outer edge portion 23, and the external force of airflow passing into the recessed passage 120 due to the centrifugal force exerted from the inner edge portion 24. Accordingly, the minimum-point portion 120m may not necessarily be formed such that its location moves monotonously from the inner area toward the outer area as the minimum-point portion 120m extends from the front edge portion 21 toward the rear edge portion 22.

### (Operational Effects of Axial Fan 100D)

The axial fan 100D allows airflow to pass through the blade 20 as described below. The airflow enters through the front edge portion 21, and as the airflow proceeds toward the rear edge portion 22, the airflow passes through the recessed passage 120 along the minimum-point portion 120m. This allows the airflow to concentrate so as to pass through the outer area of the blade 20 where a large force is imparted from the blade 20 to the airflow. This allows the axial fan 100D to efficiently impart energy to the airflow, and thus efficiently provide large airflow.

### Embodiment 6

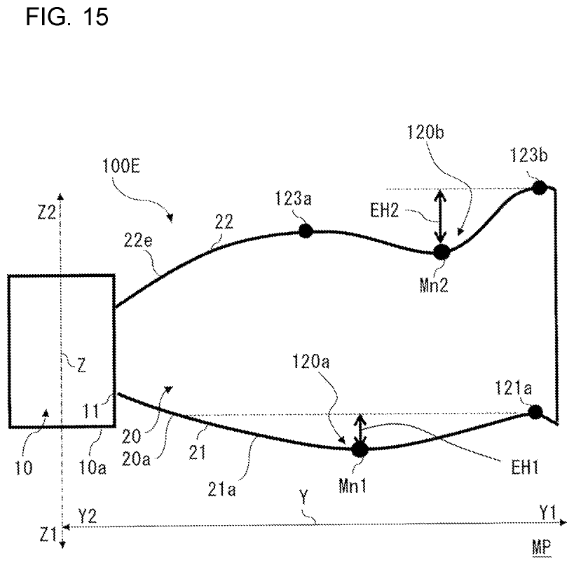

FIG. 15 illustrates an exemplary shape of an axial fan 100E according to Embodiment 6 that is rotated and projected onto a meridian plane. Parts identical in configuration to those of the axial fan 100 or other axial fans illustrated in FIGS. 1 to 14 are given the same reference signs and not described below in further detail. For the axial fan 100C according to Embodiment 6, the configurations of the front-edge recess portion 120a and the rear-edge recess portion 120b, as well as the configurations of the front-edge recess portion 120a1 and the rear-edge recess portion 120b1 are further specified. Although the configurations of the front-edge recess portion 120a and the rear-edge recess portion 120b are described below. the configurations of the front-edge recess portion 120a1 and the rear-edge recess portion 120b1 are identical to the configurations of the front-edge recess portion 120a and the rear-edge recess portion 120b, and thus are not described below in further detail.

### (Configuration of Axial Fan 100E)

The recessed shape of the front-edge recess portion 120a has a depth in the axial direction of the rotating shaft RS that is defined as a front edge height EH1. As illustrated in FIG. 15, the front edge height EH1 is the distance between the front edge minimum-point portion Mn1 and the maximum-point portion 121a in a direction parallel to the axial direction of the rotating shaft RS. Likewise, the recessed shape of the rear-edge recess portion 120b has a depth in the axial direction of the rotating shaft RS that is defined as a rear edge height EH2. As illustrated in FIG. 15, the rear edge height EH2 is the distance between the rear edge minimum-point portion Mn2 and the second maximum-point portion 123b in the direction parallel to the axial direction of the rotating shaft RS. The front edge height EH1 and the rear edge height EH2 respectively represent the depths of the recessed shapes of the front-edge recess portion 120a and the rear-edge recess portion 120b. That is, the front edge height EH1 and the rear edge height EH2 each represent a depth of the corresponding recessed shape defined as the axial height of the recessed shape from a reference point representing the most downstream wall (closest to Z2) located in the outer area of the recessed shape, to a minimum point representing the most upstream wall (closest to Z1) of the recessed shape.

The axial fan 100E is formed such that the rear edge height EH2 of the rear-edge recess portion 120b is greater than the front edge height EH1 of the front-edge recess portion 120a. That is, in the axial fan 100E, the rear-edge recess portion 120b corresponding to the second recess portion has a depth greater than the depth of the front-edge recess portion 120a corresponding to the first recess portion in the axial direction of the rotating shaft RS.

### (Operational Effects of Axial Fan 100E)

Generally speaking, in an area near the rear end portion of an axial fan, the pressure of airflow increases, and the airflow tends to leak outward due to centrifugal force. The axial fan 100E is formed such that in an area near the rear edge portion 22 that is subject to increased airflow pressure and the influence of centrifugal force, the rear edge height EH2 of the rear-edge recess portion 120b is greater than the front edge height EH1 of the front-edge recess portion 120a, The configuration of the axial fan 100E mentioned above helps to ensure that in an area near the rear edge portion 22 that is subject to increased airflow pressure and the influence of centrifugal force, leakage of airflow toward the outer area of the blade 20 is reduced. This makes it possible to reliably direct the airflow through the recessed passage 120.

### Embodiment 7

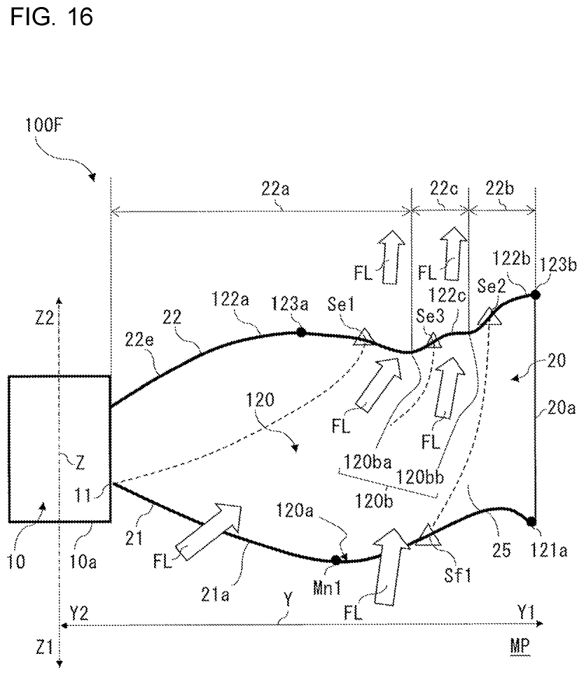

FIG. 16 illustrates an exemplary shape of an axial fan 100F according to Embodiment 7 that is rotated and projected onto a meridian plane. Parts identical in configuration to those of the axial fan 100 or other axial fans illustrated in FIGS. 1 to 15 are given the same reference signs and not described below in further detail. For the axial fan 100F according to Embodiment 7, the configuration of the blade 20 is further specified. Although the configuration of the rear-edge recess portion 120b is described below, the configuration of the rear-edge recess portion 120b1 is identical to the configurations of the rear-edge recess portion 120b, and thus is not described below in further detail.

### (Rear Edge Portion 22)

In the meridian plane MP onto which the rear edge portion 22 is rotated and projected, the rear-edge projected portion 22e is formed by a curve including S-shaped portions. The rear-edge projected portion 22e has the first S-shaped portion 22a, the second S-shaped portion 22b, and a third S-shaped portion 22c. The first S-shaped portion 22a, the second S-shaped portion 22b, and the third S-shaped portion 22c of the rear-edge projected portion 22e are each formed by an S-shaped curve that arcs upstream and downstream in the airflow. The rear-edge projected portion 22e is formed by a curve including a combination of the first S-shaped portion 22a, the second S-shaped portion 22b, and the third S-shaped portion 22c located between the first S-shaped portion 22a and the second S-shaped portion 22b.

The rear-edge projected portion 22e has the rear edge first-inflection-point portion Se1, which is a point of inflection of the first S-shaped portion 22a, the rear edge second-inflection-point portion Set, which is a point of inflection of the second S-shaped portion 22b, and a rear edge third-inflection-point portion Se3, which is a point of inflection of the third S-shaped portion 22c. In the direction perpendicular to the rotating shaft RS, that is, in the radial direction of the axial fan 100, the rear edge first-inflection-point portion Set is formed further inside than is the rear edge second-inflection-point portion Se2. In the direction perpendicular to the rotating shaft RS, that is, in the radial direction of the axial fan 100, the rear edge third-inflection-point portion Se3 is formed between the rear edge first-inflection-point portion Set and the rear edge second-inflection-point portion Se2.

### (Rear-Edge Recess Portion 120b)

The rear-edge projected portion 22e has, between the rear edge first-inflection-point portion Set and the rear edge second-inflection-point portion Se2, the rear-edge recess portion 120b formed in a recessed shape that recedes upstream (toward Z1), The rear-edge recess portion 120b has a rear-edge inner recess portion 120ba, which is formed in a recessed shape receding upstream in the airflow, and a rear-edge outer recess portion 120bb, which is formed in a recessed shape receding upstream in the airflow. The rear-edge inner recess portion 120ba corresponds to a third recess portion of the axial fan 100, and the rear-edge outer recess portion 120bb corresponds to a fourth recess portion of the axial fan 100. The rear-edge inner recess portion 120ba is formed further inside of the blade 20 than is the rear-edge outer recess portion 120bb, and the rear-edge outer recess portion 120bb is formed further outside of the blade 20 than is the rear-edge inner recess portion 120ba. The rear-edge inner recess portion 120ba and the rear-edge outer recess portion 120bb each form an arc that recedes upstream (toward Z1) in the rear-edge projected portion 22e. The rear-edge inner recess portion 120ba and the rear-edge outer recess portion 120bb are formed so as to extend from a central part of the blade 20 to the rear-edge projected portion 22e in a direction opposite to the rotation direction DR of the axial fan 100F.

The rear-edge projected portion 22e has the first ridge portion 122a that forms an arc protruding downstream (toward Z2). The rear-edge projected portion 22e has the second ridge portion 122b that forms an arc protruding downstream (toward Z2). Further, the rear-edge recess portion 120b of the rear-edge projected portion 22e has a third ridge portion 122c that forms an arc protruding downstream (toward Z2). The rear-edge recess portion 120b is formed between the first ridge portion 122a and the second ridge portion 122b. The rear-edge inner recess portion 120ba is formed between the first ridge portion 122a and the third ridge portion 122c. The rear-edge outer recess portion 120bb is formed between the third ridge portion 122c and the second ridge portion 122b. In the rear-edge projected portion 22e, the first ridge portion 122a, the rear-edge recess portion 120b, and the second ridge portion 122b are formed in this order from the inner area toward the outer area in the radial direction of the axial fan 100. In the rear-edge recess portion 120b, the rear-edge inner recess portion 120ba, the third ridge portion 122c, and the rear-edge outer recess portion 120bb are formed. Accordingly, in the rear-edge projected portion 22e, the first ridge portion 122a, the rear-edge inner recess portion 120ba, the third ridge portion 122c, the rear-edge outer recess portion 120bb, and the second ridge portion 122b are formed in this order from the inner area toward the outer area in the radial direction of the axial fan 100.

The axial fan 100F has the rear edge third-inflection-point portion Se3 located between the rear edge first-inflection-point portion Set and the rear edge second-inflection-point portion Set of the rear-edge projected portion 22e that define the recessed passage 120. The axial fan 100F has the third ridge portion 122c provided in the rear-edge recess portion 120b. Due to the configuration of the axial fan 100F mentioned above, the recessed passage 120 is formed such that from a central part of the blade 20 to the rear-edge projected portion 22e in the circumferential direction of the axial fan 100F, the recessed passage 120 splits into two passages, one leading toward the rear-edge inner recess portion 120ba and the other leading toward the rear-edge outer recess portion 120bb. That is, due to the configuration of the axial fan 100F mentioned above, the recessed passage 120 is formed such that from a central part of the blade 20 to the rear-edge projected portion 22e in the circumferential direction of the axial fan 100F, the recessed passage 120 splits into multiple parts.

Due to the presence of the rear-edge inner recess portion 120ba and the rear-edge outer recess portion 120bb, the axial fan 100F has longitudinal grooves on the pressure surface 25 of the blade 20 that extend in the direction of flow of air. The axial fan 100F thus has features shaped like commonly called riblets on the pressure surface 25 of the blade 20. As illustrated in FIG. 16, in a part of the blade 20 near the rear edge portion 22, the airflow entering through the front edge portion 21 splits into two flows that pass along the recessed passage 120.

### (Operational Effects of Axial Fan 100F)

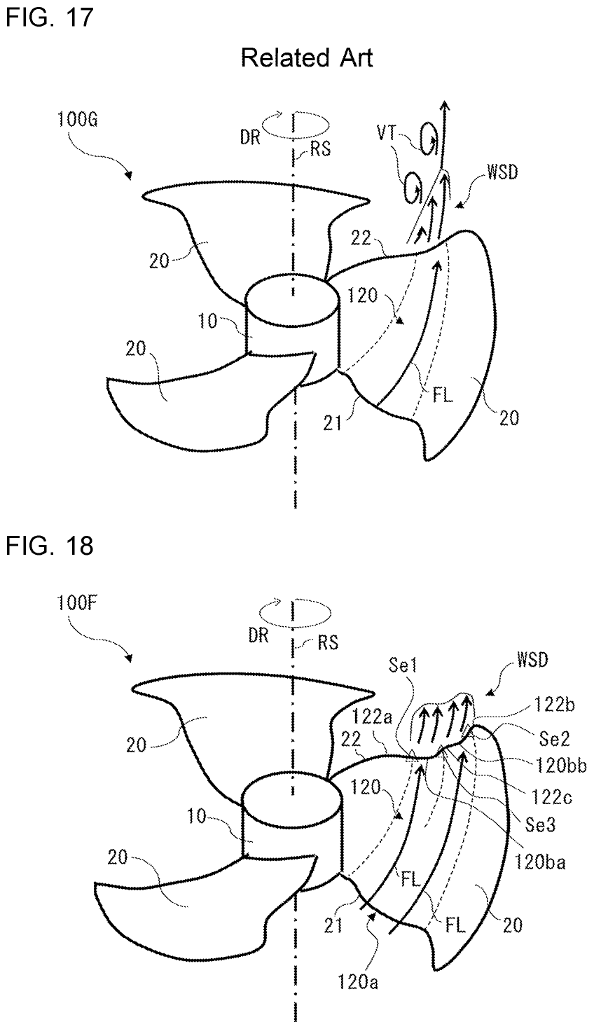

FIG. 17 is a perspective view of an axial fan 100G according to a comparative example, illustrating how airflow blows from the axial fan 100G. The axial fan 100E according to the comparative example corresponds in configuration to each of the axial fans 100 to 100E according to Embodiments 1 to 6. In the axial fan 100G, the airflow passing through a part of the recessed passage 120 near the rear edge portion 22 concentrates toward the outer area of the recessed passage 120 as illustrated in FIG. 17. The resulting wind speed distribution WSD is formed such that the outgoing flow has an increased wind speed in the outer area of the recessed passage 120.

Therefore, in the rear edge portion 22 of the axial fan 100G, the resulting difference in wind speed may cause vortices VT to develop in some cases. The vortices VT generated in the rear edge portion 22 can cause axial energy loss, and can also cause increased noise generation.

FIG. 18 is a perspective view of an axial fan 100F according to Embodiment 7, illustrating how airflow blows from the axial fan 100F, As illustrated in FIG. 18, in contrast to the axial fan 100G according to the comparative example, the axial fan 100F according to Embodiment 7 causes airflow to pass along the recessed passage 120 that is subdivided into multiple parts near the rear edge portion 22. The rear-edge recess portion 120b of the axial fan 100F has the rear-edge inner recess portion 120ba, which corresponds to the third recess portion formed in a recessed shape receding upstream in the airflow, and the rear-edge outer recess portion 120bb, which corresponds to the fourth recess portion formed in a recessed shape receding upstream in the airflow. Due to the configuration of the axial fan 100F mentioned above, in a portion of the recessed passage 120 near the rear edge portion 22, airflow that tends to concentrate locally is streamlined by the finely subdivided portions of the recessed passage 120. This helps to ensure that the outgoing airflow from the blade 20 does not concentrate in a narrow area. This leads to uniform airflow velocity. Consequently, as illustrated in FIG. 18, the axial fan 100F allows for uniform wind speed distribution WSD of the outgoing flow from the inner area to the outer area of the recessed passage 120. As a result, the axial fan 100F allows for reduced generation of vortices VT near the rear edge portion 22, reduced energy loss caused by such generation of the vortices VT, and further, reduced noise generation caused by the vortices VT. That is, the above-mentioned configuration of the axial fan 100F helps to reduce energy loss resulting from a difference in velocity that develops as a high velocity flow and a low velocity flow mix together after exiting the axial fan 100F.

### Embodiment 8

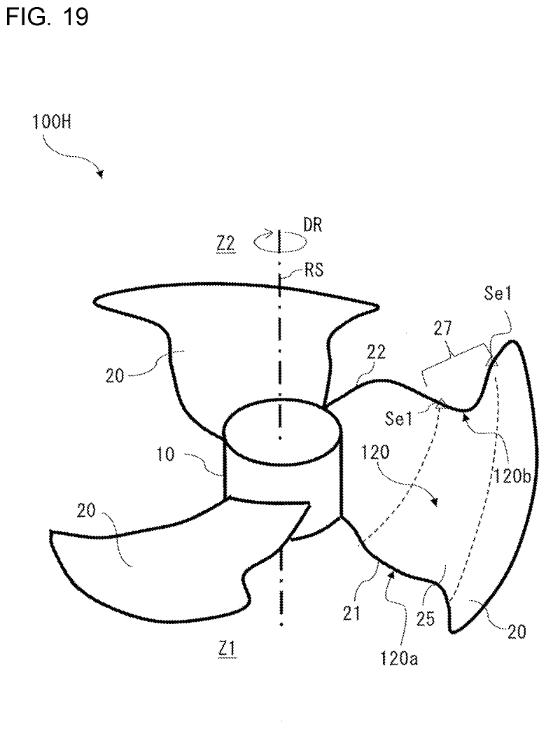

FIG. 19 is a schematic perspective view of an axial fan 100H according to Embodiment 8. Parts identical in configuration to those of the axial fan 100 or other axial fans illustrated in FIGS. 1 to 18 are given the same reference signs and not described below in further detail. For the axial fan 100H according to Embodiment 8, the configuration of the rear edge portion 22 of the blade 20 is further specified. The shape of the axial fan 100H according to Embodiment 8 rotated and projected on the meridian plane MP illustrated in FIG. 1 is identical to the shape of the axial fan 100 illustrated in FIG. 2.

### (Configuration of Axial Fan 100H)

In plan view parallel to the rotating shaft RS, the rear edge portion 22 has a portion defining the rear-edge recess portion 120b and having an edge, and the edge has a notched portion 27 formed by notching the edge toward the front edge portion 21. The rear edge portion 22 of the blade 20 has at least one such notched portion 27. The notched portion 27 corresponds to where the rear edge portion 22 defining the blade 20 has the shape of a notch that is notched in the circumferential direction of the axial fan 100H. That is, the notched portion 27 is a portion of the rear edge portion 22 that has the shape of a notch that is notched from the rear edge portion 22 toward the front edge portion 21. The blade 20 is formed such that its edge defining the notched portion 27 has a radial width that decreases toward the front edge portion 21. In the notched portion 27, the rear edge portion 22 defines an edge that recedes toward the front edge portion 21. The notched portion 27 opens in a direction opposite to the rotation direction DR. In plan view parallel to the axial direction of the rotating shaft RS, an edge of the rear edge portion 22 that defines the notched portion 27 is formed in, for example, a U-shape or a V-shape.

The notched portion 27 is formed between the rear edge first-inflection-point portion Set and the rear edge second-inflection-point portion Se2. That is, the notched portion 27 is formed in the rear-edge recess portion 120b of the rear edge portion 22. Therefore, the rear-edge recess portion 120b forms an arc that recedes upstream (toward Z1), and defines an edge that recedes toward the front edge portion 21 due to the presence of the notched portion 27.

### (Operational Effects of Axial Fan 100H)

The axial fan 100F according to Embodiment 7 described above allows the wind speed distribution WSD of the outgoing flow to be made uniform from the inner area to the outer area of the recessed passage 120. However, the above-mentioned approach, that is, adding irregularities to the recessed passage 120 to achieve uniform outgoing wind speed as with the axial fan 100F according to Embodiment 7, has a potential problem in that depending on the radial width, it may be difficult to provide the irregularities on the pressure surface 25 with an elevation difference.

In the axial fan 100H according to Embodiment 8, the presence of the notched portion 27 in the rear-edge recess portion 120b makes it possible to adjust the chord length WL depicted in FIG. 6. This configuration of the axial fan 100H helps to reduce the force with which the blade 20 pushes airflow in the recessed passage 120. This further facilitates creation of an outgoing wind speed distribution aimed to achieve uniform outgoing wind speed. Further, the above-mentioned configuration of the axial fan 100H results in reduced wind speed difference between the outer and inner areas of the recessed passage 120. This helps to reduce energy loss resulting from a difference in velocity that develops as a high velocity flow and a low velocity flow mix together after exiting the axial fan 100H.

### Embodiment 9

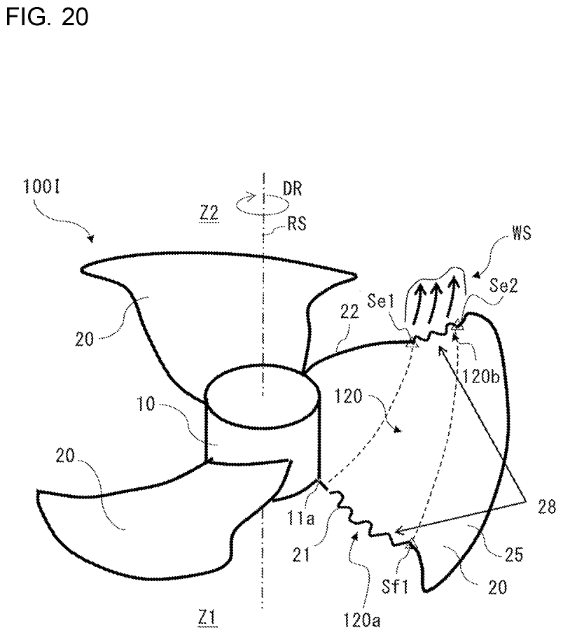

FIG. 20 is a schematic perspective view of an axial fan 1001 according to Embodiment 9. Parts identical in configuration to those of the axial fan 100 or other axial fans illustrated in FIGS. 1 to 19 are given the same reference signs and not described below in further detail. For the axial fan 1001 according to Embodiment 9, the configuration of the front edge portion 21 of the blade 20, and the configuration of the rear edge portion 22 of the blade 20 are further specified.

### (Configuration of Axial Fan 1001)

The front edge portion 21 has a portion defining the front-edge recess portion 120a and having an edge, and the edge has a corrugated serration 28. Alternatively, the rear edge portion 22 has a portion defining the rear-edge recess portion 120b and having an edge, and the edge has the corrugated serration 28. The front edge portion 21 and the rear edge portion 22 of the blade 20 are provided with at least one serration 28. The serration 28 may be provided only in the front edge portion 21, or may be provided only in the rear edge portion 22. Alternatively, the serration 28 may be provided in both the front edge portion 21 and the rear edge portion 22. In plan view parallel to the axial direction of the rotating shaft RS, the serration 28 is a grooved portion in the shape of saw teeth or fine corrugations formed at an edge of the front edge portion 21 or the rear edge portion 22. The grooves defining the serration 28 are formed in an edge portion of the blade 20 so as to extend between an area upstream (near Z1) in the airflow and an area downstream (near Z2) in the airflow

The serration 28 is formed in the rear edge portion 22 between the rear edge first-inflection-point portion Set and the rear edge second-inflection-point portion Set. That is, the serration 28 is formed in the rear-edge recess portion 120b of the rear edge portion 22. The serration 28 is formed in the front edge portion 21 between the front-edge base portion 11a and the front edge inflection-point portion Sf1. That is, the serration 28 is formed in the front-edge recess portion 120a of the front edge portion 21.

### (Operational Effects of Axial Fan 1001)

The presence of the serration 28 in the front-edge recess portion 120a helps to ensure that if the direction of airflow and the direction of the leading edge of the blade 20 are greatly misaligned due to external disturbances, the airflow at the leading edge of the blade 20 can be disturbed by the serration 28 to thereby make the direction of airflow less clearly defined. As a result, the axial fan 1001 with the serration 28 provided in the front-edge recess portion 120a allows airflow to be easily directed into the front-edge recess portion 120a, in comparison to an axial fan with no such serration 28 provided in the front-edge recess portion 120a.

The serration 28 provided to the rear-edge recess portion 120b makes it possible to disturb airflow that concentrates locally in the rear-edge recess portion 120b to thereby eliminate areas of extremely high outgoing wind speed. As a result, the axial fan 1001 allows for reduced generation of vortices VT near the rear edge portion 22, reduced energy loss caused by such generation of the vortices VT, and further, reduced noise generation caused by the vortices VT.

### Embodiment 10

Embodiment 10 is directed to using the axial fan 100 or other axial fans according to Embodiments 1 to 9 for an outdoor unit 50, which is used as an air-sending device of a refrigeration cycle apparatus 70.

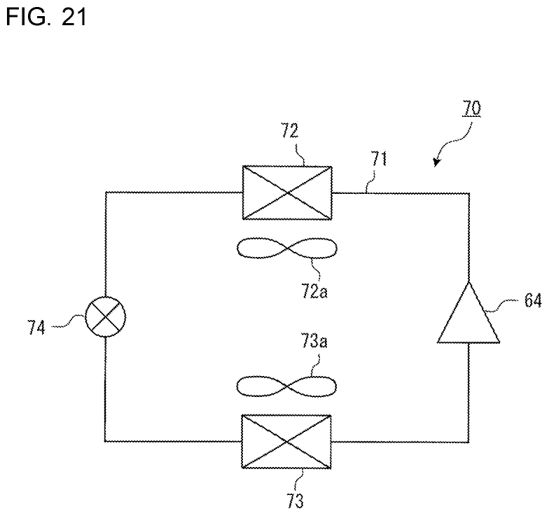

FIG. 21 is a schematic diagram of the refrigeration cycle apparatus 70 according to Embodiment 10. Although the following description is directed to the refrigeration cycle apparatus 70 used for air-conditioning purposes, this is not intended to limit the use of the refrigeration cycle apparatus 70 to air conditioning. For example, the refrigeration cycle apparatus 70 is used for refrigeration or air-conditioning purposes, such as for refrigerators, freezers, vending machines, air-conditioning apparatuses, refrigeration apparatuses, and water heaters.

As illustrated in FIG. 21, the refrigeration cycle apparatus 70 includes a refrigerant circuit 71 formed by sequentially connecting a compressor 64, a condenser 72, an expansion valve 74, and an evaporator 73 by a refrigerant pipe. A condenser fan 72a, which sends air used for heat exchange to the condenser 72, is provided to the condenser 72. An evaporator fan 73a, which sends air used for heat exchange to the evaporator 73, is provided to the evaporator 73. At least one of the condenser fan 72a and the evaporator fan 73a is the axial fan 100 according to any one of Embodiments 1 to 9 mentioned above. The refrigeration cycle apparatus 70 may be configured to switch between heating operation and cooling operation, by providing the refrigerant circuit 71 with a flow switching device such as a four-way valve that switches the flows of refrigerant.

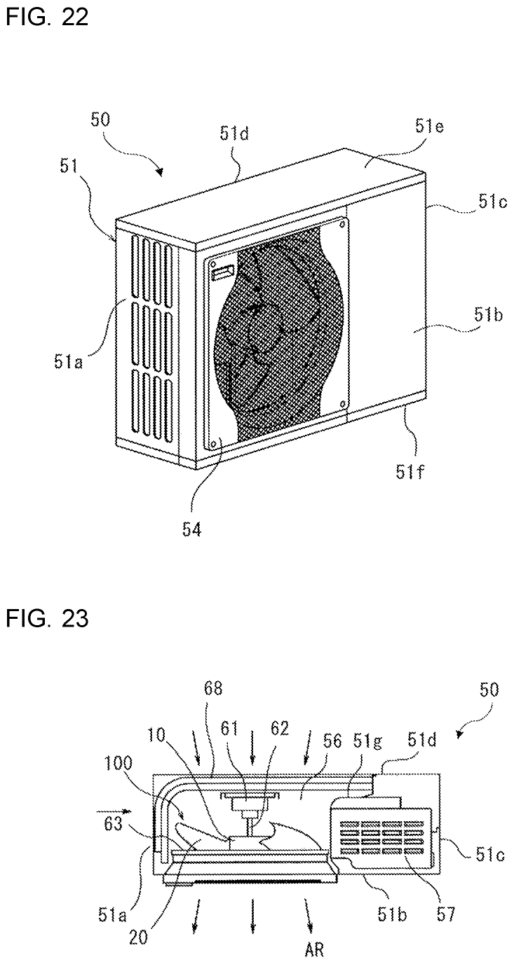

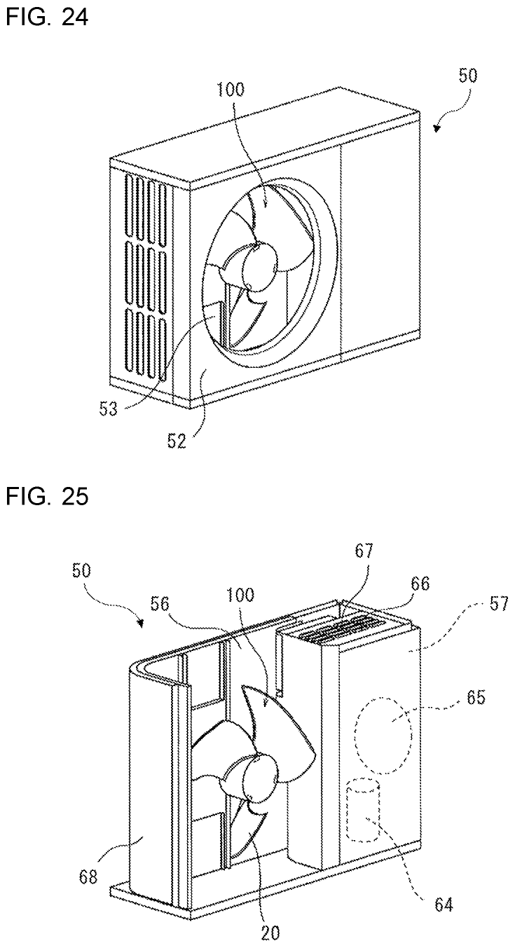

FIG. 22 is a perspective view, as seen from an air outlet, of the outdoor unit 50 used as an air-sending device. FIG. 23 is a top view of the outdoor unit 50 for explaining the configuration of the outdoor unit 50. FIG. 24 illustrates the outdoor unit 50 with a fan grille removed from the outdoor unit 50. FIG. 25 illustrates the internal configuration of the outdoor unit 50 with the fan grille, a front panel, and other components removed from the outdoor unit 50.

As illustrated in FIGS. 22 to 25, an outdoor unit body 51 used as a casing is formed as an enclosure having the following surfaces: a lateral surface 51a and a lateral surface 51c, which define a pair of left and right lateral surfaces; a front surface 51b; a back surface 51d; a top surface 51e, and a bottom surface 51f. The lateral surface 51a and the back surface 51d each have an opening for suctioning air from outside. The front surface 51b has an air outlet 53 formed in a front panel 52 to blow air outside. Further, the air outlet 53 is covered with a fan grille 54 to ensure safety by preventing contact between the axial fan 100 and, for example, an object located outside the outdoor unit body 51. Arrows AR in FIG. 23 represent the flow of air.

The axial fan 100 and a fan motor 61 are accommodated in the outdoor unit body 51. The axial fan 100 is connected via a rotating shaft 62 to the fan motor 61, which is a drive source located near the back surface 51d. The axial fan 100 is driven to rotate by the fan motor 61. The fan motor 61 provides a drive force to the axial fan 100.

The interior of the outdoor unit body 51 is divided by a partition plate 51g, which is a wall element, into an air-sending chamber 56 in which the axial fan 100 is installed, and a machine chamber 57 in which the compressor 64 and other components are installed. A heat exchanger 68, which extends in a substantially L-shape in plan view, is disposed in the air-sending chamber 56 near the lateral surface 51a and the back surface 51d. The heat exchanger 68 is used as the condenser 72 during heating operation, and is used as the evaporator 73 during cooling operation.

A bellmouth 63 is disposed radially outward of the axial fan 100 disposed in the air-sending chamber 56. The bellmouth 63 is located further outside than is the outer end of the blades 20, and defines an annular shape in the direction of rotation of the axial fan 100. The partition plate 51g is located beside one side of the bellmouth 63, and a portion of the heat exchanger 68 is located beside the other side of the bellmouth 63.

The front end of the bellmouth 63 is connected to the front panel 52 of the outdoor unit 50 so as to surround the periphery of the air outlet 53. The bellmouth 63 may be integral with the front panel 52, or may be provided as a separate component that can be connected to the front panel 52. Due to the presence of the bellmouth 63, the passage between the inlet side and the outlet side of the bellmouth 63 is defined as an air passageway near the air outlet 53. That is, the air passageway near the air outlet 53 is partitioned off by the bellmouth 63 from other spaces in the air-sending chamber 56.

The heat exchanger 68 disposed near the air inlet of the axial fan 100 includes fins with plate-like surfaces arranged side by side in parallel to each other, and heat transfer tubes penetrating the fins in a direction in which the fins are arranged side by side. Refrigerant that circulates in the refrigerant circuit flows in the heat transfer tubes. In the heat exchanger 68 according to Embodiment 10, rows of heat transfer tubes extend in an L-shape over the lateral surface 51a and the back surface 51d of the outdoor unit body 51, and follow a meandering path while penetrating the fins. The heat exchanger 68 is connected to the compressor 64 via a pipe 65 or other components, and is further connected to an indoor-side heat exchanger (not illustrated), the expansion valve, and other components to form the refrigerant circuit 71 of the air-conditioning apparatus. A board case 66 is disposed in the machine chamber 57. A control board 67 disposed in the board case 66 controls devices mounted in the outdoor unit.

### (Operation Effects of Refrigeration Cycle Apparatus 70)

Embodiment 10 can provide advantages similar to Embodiments 1 to 9 corresponding to Embodiment 10. For example, as described above, the axial fans 100 to 1001 allow the airflow received at the front edge portion 21 of each blade 20 to easily flow, in the rotation direction DR of the blade 20, through the outer area of the pressure surface 25 where force is efficiently imparted from the blade 20 to the airflow. Mounting one or more of the axial fans 100 to 1001 to an air-sending device makes it possible for the air-sending device to efficiently send air at increased flow rate. By mounting one or more of the axial fans 100 to 1001 to an air-conditioning apparatus or water-heating outdoor unit that is used as the refrigeration cycle apparatus 70 including components such as the compressor 64 and a heat exchanger, an increase in flow rate of airflow through the heat exchanger can be gained with low noise and high efficiency, which leads to reduced noise and improved energy saving for the apparatus.

The configurations described in the foregoing description of the embodiments are intended to be illustrative only. These configurations can be combined with other known techniques, or can be partially omitted or changed without departing from the scope of the disclosure.

### REFERENCE SIGNS LIST

10: hub, 10a: hub projected portion, 11: base portion, 11a: front-edge base portion, 11b: rear-edge base portion, 20: blade, 20a: blade projected portion, 21: front edge portion, 21a: front-edge projected portion, 22: rear edge portion, 22a: first 5-shaped portion, 22b: second S-shaped portion, 22c: third S-shaped portion, 22e: rear-edge projected portion, 23: outer edge portion, 24: inner edge portion, 25: pressure surface, 26: suction surface, 27: notched portion, 28: serration, 50: outdoor unit, 51: outdoor unit body, 51a: lateral surface, 51b: front surface, 51c: lateral surface, 51d: back surface, 51e: top surface, 51f: bottom surface, 51g: partition plate, 52: front panel, 53: air outlet, 54: fan grille, 56: air-sending chamber, 57: machine chamber, 61: fan motor, 62: rotating shaft, 63: bellmouth, 64: compressor, 65: pipe, 66: board case, 67: control board, 68: heat exchanger, 70: refrigeration cycle apparatus, 71: refrigerant circuit, 72: condenser, 72a: condenser fan, 73: evaporator, 73a: evaporator fan, 74: expansion valve, 100: axial fan, 100A: axial fan, 100B: axial fan, 100C: axial fan, 100D: axial fan, 100E: axial fan, 100F: axial fan, 1000: axial fan, 100H: axial fan, 1001: axial fan, 120: recessed passage, 120a: front-edge recess portion, 120a1: front-edge recess portion, 120b: rear-edge recess portion, 120b1: rear-edge recess portion, 120ba: rear-edge inner recess portion, 120bb: rear-edge outer recess portion, 120m: minimum-point portion, 121: front-edge ridge portion, 121a: maximum-point portion, 122a: first ridge portion, 122b: second ridge portion, 122c: third ridge portion, 123a: first maximum-point portion, 123b: second maximum-point portion

1. An axial fan, comprising:
a hub having a rotating shaft and configured to be driven to rotate; and
blades provided to the hub, the blades each having a front edge portion and a rear edge portion,
in a state in which the blades rotate to generate an airflow, the front edge portion being placed most upstream in the airflow, and the rear edge portion being placed most downstream in the airflow,
in a shape of the blades rotated and projected onto a meridian plane that covers shapes of the blades and a shape of the rotating shaft,
the front edge portion having an outline represented by a front-edge projected portion having a first recess portion formed in a recessed shape that recedes upstream in the airflow,
the rear edge portion having an outline represented by a rear-edge projected portion having a second recess portion formed in a recessed shape that recedes upstream in the airflow,
the first recess portion having at least a portion that is formed further radially inside than is the second recess portion.

2. The axial fan of claim 1,
wherein the front-edge projected portion has a front edge inflection-point portion used as a point of inflection, the front-edge projected portion being formed by an S-shaped curve that arcs upstream and downstream in the airflow,
wherein the first recess portion is formed between a base portion of the front edge portion and the front edge inflection-point portion, the base portion being a root joint of the front edge portion with the hub,
wherein the rear-edge projected portion has
a first S-shaped portion having a first inflection-point portion used as a point of inflection, the first S-shaped portion being formed by an S-shaped curve that arcs upstream and downstream in the airflow, and
a second S-shaped portion having a second inflection-point portion used as a point of inflection, the second S-shaped portion being formed by an S-shaped curve that arcs upstream and downstream in the airflow, and
wherein the second recess portion is formed between the first inflection-point portion and the second inflection-point portion.

3. The axial fan of claim 2, wherein the front edge inflection-point portion is located radially between the first inflection-point portion and the second inflection-point portion.

4. The axial fan of claim 2,
wherein the rear-edge projected portion further has a third S-shaped portion disposed between the first S-shaped portion and the second S-shaped portion, the third S-shaped portion having a third inflection-point portion used as a point of inflection, the third S-shaped portion being formed by an S-shaped curve that arcs upstream and downstream in the airflow, and
wherein the second recess portion has
a third recess portion formed in a recessed shape that recedes upstream in the airflow, and
a fourth recess portion formed in a recessed shape that recedes upstream in the airflow.

5. The axial fan of claim 1, wherein the second recess portion is formed further radially outside than is the first recess portion.

6. The axial fan of claim 1,
wherein the first recess portion of the front-edge projected portion has a first minimum-point portion, the first minimum-point portion being located most upstream in the airflow,
wherein the second recess portion of the rear-edge projected portion has a second minimum-point portion, the second minimum-point portion being located most upstream in the airflow, and
wherein the second minimum-point portion is formed further radially outside than is the first minimum-point portion.

7. The axial fan of claim 1, wherein the second recess portion has a width less than a width of the first recess portion in a radial direction.

8. The axial fan of claim 1, wherein the front-edge projected portion has, in a radial direction, a proportion of the first recess portion greater than a proportion of a portion formed in a recessed shape that recedes downstream in the airflow.

9. The axial fan of claim 1, wherein in plan view parallel to the rotating shaft, the rear edge portion has a portion defining the second recess portion and having an edge, the rear edge portion having a notched portion formed by notching the edge toward the front edge portion.

10. The axial fan of claim 1, wherein the front edge portion has a portion defining the first recess portion and having an edge, the edge having a corrugated serration.

11. The axial fan of claim 1, wherein the rear edge portion has a portion defining the second recess portion and having an edge, the edge having a corrugated serration.

12. The axial fan of claim 1, wherein the second recess portion has a depth greater than a depth of the first recess portion in an axial direction of the rotating shaft.

13. The axial fan of claim 1,
wherein the blades each have a pressure surface defining a surface that faces downstream in the airflow,
wherein the pressure surface has a recessed passage formed in a recessed shape that recedes upstream in the airflow,
wherein the recessed passage is formed between the front edge portion and the rear edge portion, and
wherein in a circumferential direction, the recessed passage has an end portion near the front edge portion that is defined by a portion of the recessed passage that defines the first recess portion, and the recessed passage has an end portion near the rear edge portion that is defined by a portion of the recessed passage that defines the second recess portion.

14. The axial fan of claim 13, wherein the recessed passage has a minimum-point portion, the minimum-point portion defining a most upstream portion of a cross-section of the recessed passage in a radial direction and extending continuously between the front edge portion and the rear edge portion, the minimum-point portion being directed radially outward as the minimum-point portion extends from the front edge portion to the rear edge portion.

15. An air-sending device, comprising:
the axial fan of claim 1;
a drive source configured to provide a drive force to the axial fan; and
a casing that accommodates the axial fan and the drive source.

16. A refrigeration cycle apparatus, comprising:
the air-sending device of claim 15; and
a refrigerant circuit having a condenser and an evaporator,
the air-sending device being configured to send air to at least one of the condenser and the evaporator.
